(19) United States
(12) Patent Application Publication
(10) Pub. No.: US 2020/0183019 A1
(43) Pub. Date: Jun. 11, 2020

(54) INFORMATION PROCESSING APPARATUS, INFORMATION PROCESSING SYSTEM, METHOD FOR OUTPUTTING RESULT OF POSITIONING, AND NON-TRANSITORY COMPUTER-READABLE MEDIUM STORING PROGRAM

(71) Applicant: NEC Solution Innovators, Ltd., Koto-ku, Tokyo (JP)

(72) Inventors: Ryo MIYAMOTO, Tokyo (JP); Maho KASHIWAGI, Tokyo (JP); Yuka KANDA, Tokyo (JP)

(73) Assignee: NEC Solution Innovators, Ltd., Koto-ku, Tokyo (JP)

(21) Appl. No.: 16/642,092

(22) PCT Filed: Aug. 8, 2018
(86) PCT No.: PCT/JP2018/029830

§ 371 Date: Feb. 26, 2020

(30) Foreign Application Priority Data
Sep. 5, 2017 (JP) 2017-170169

(51) Int. Cl. G01S 19/52; G01C 21/28

(52) U.S. Cl. CPC G01S 19/52; G05D 1/0088; G01C 21/28

(57) ABSTRACT

An information processing apparatus includes a movement amount calculation unit (110) configured to calculate a movement of an object based on positional information indicating a position of the object, a comparison unit (120) configured to compare the movement calculated by the movement amount calculation unit (110) with a predetermined threshold, and an output unit (130) configured to output a result of the comparison made in the comparison unit (120). By this configuration, for example, the information processing apparatus outputs a result of the comparison between the movement of the object calculated based on the positional information indicating the position of the object calculated by satellite positioning and a predetermined threshold. Therefore, it is possible to determine the reliability of the result of the satellite positioning more accurately.

### TECHNICAL FIELD

The present invention relates to an information processing apparatus, an information processing system, a method for outputting a result of positioning, and a program.

### BACKGROUND ART

In recent years, various developments and experiments have been made and carried out for the practical use of self-driving technologies for automobiles. In the self-driving technology, it is necessary to accurately recognize the position of a vehicle to be driven. In order to acquire positional information indicating the position of the vehicle, it is common to use, for example, a satellite positioning technique using GPS (Global Positioning System) satellites.

When the satellite positioning technique is used, it is conceivable that there are cases in which correct positional information cannot be obtained due to various factors. Examples of the factors include an orbit error of a satellite, a clock error, changes in the ionosphere, changes in the troposphere, signal interceptions that are caused when radio waves are blocked by clouds, mountains and forests, or buildings, and multipath reception that are caused when radio waves are reflected by mountains and forests, or buildings such as high-rise buildings. If the correct positional information cannot be obtained, the reliability of the result of the positioning deteriorates.

Therefore, a technique in which, of the degree of reliability of a result of positioning using a GPS function and the degree of reliability of a result of positioning using autonomous navigation positioning, a result of positioning having the higher reliability is selected has been proposed (see, for example, Patent Literature 1).

### CITATION LIST

### Patent Literature

Patent Literature 1: Japanese Patent No. 5309643

### SUMMARY OF INVENTION

### Technical Problem

In the technique disclosed in Patent Literature 1, the degree of reliability of a result of satellite positioning is calculated based on HDOP (Horizontal Dilution of Precision) information and/or SN (Signal to Noise Ratio) information. Therefore, the calculation is based on the environment in which the positioning is performed and hence it is impossible to make a decision based on the actual movement of the object. That is, there is a problem that the reliability of the result of the satellite positioning cannot be accurately determined in the technique disclosed in Patent Literature 1.

An object of the present invention is to provide an information processing apparatus, an information processing system, a method for outputting a result of positioning, and a program capable of solving the above-described problem.

### Solution to Problem

An information processing apparatus according to the present invention includes:

a movement amount calculation unit configured to calculate a movement of an object based on positional information indicating a position of the object calculated by satellite positioning;

a comparison unit configured to compare the movement calculated by the movement amount calculation unit with a predetermined threshold; and

an output unit configured to output a result of the comparison made in the comparison unit.

Further, an information processing apparatus includes:

a movement amount calculation unit configured to calculate a movement of an object based on positional information indicating a position of the object calculated by satellite positioning;

a score acquisition unit configured to acquire a score corresponding to the movement calculated by the movement amount calculation unit; and

an output unit configured to output the score acquired by the score acquisition unit.

Further, an information processing system according to the present invention includes

a receiver disposed in an object, and an information processing apparatus, in which

the receiver includes a transmitting unit configured to calculate a position of the object based on data received from a satellite configured to perform satellite positioning, and transmit positional information indicating the calculated position to the information processing apparatus, and the information processing apparatus includes:

a movement amount calculation unit configured to calculate a movement of an object based on the positional information transmitted from the transmitting unit;

a comparison unit configured to compare the movement calculated by the movement amount calculation unit with a predetermined threshold; and

an output unit configured to output a result of the comparison made in the comparison unit.

Further, an information processing system includes

a receiver disposed in an object, and an information processing apparatus, in which

the receiver includes a transmitting unit configured to calculate a position of the object based on data received from a satellite configured to perform satellite positioning, and transmit positional information indicating the calculated position to the information processing apparatus, and the information processing apparatus includes:

a movement amount calculation unit configured to calculate a movement of an object based on the positional information transmitted from the receiver;

a score acquisition unit configured to acquire a score corresponding to the movement calculated by the movement amount calculation unit; and

an output unit configured to output the score acquired by the score acquisition unit.

Further, a method for outputting a result of positioning according to the present invention includes:

a process of calculating a movement of an object based on positional information indicating a position of the object calculated by satellite positioning;

a process of comparing the calculated movement with a predetermined threshold; and

a process of outputting a result of the comparison.

Further, a method for outputting a result of positioning includes:

a process of calculating a movement of an object based on positional information indicating a position of the object calculated by satellite positioning;

a process of acquiring a score corresponding to the calculated movement; and

a process of outputting the acquired score.

Further, a program according to the present invention is a program for causing a computer to execute:

a procedure of calculating a movement of an object based on positional information indicating a position of the object calculated by satellite positioning;

a procedure of comparing the calculated movement with a predetermined threshold; and

a procedure of outputting a result of the comparison.

Further, a program causes a computer to execute:

a procedure of calculating a movement of an object based on positional information indicating a position of the object calculated by satellite positioning;

a procedure of acquiring a score corresponding to the calculated movement; and

a procedure of outputting the acquired score.

### Advantageous Effects of Invention

As described above, in the present invention, it is possible to determine the reliability of a result of satellite positioning more accurately.

### BRIEF DESCRIPTION OF DRAWINGS

FIG. 1 shows a first example embodiment of an information processing apparatus according to the present invention;

FIG. 2 is a flowchart for explaining an example of a method for outputting a result of positioning in the information processing apparatus shown in FIG. 1;

FIG. 3 shows a second example embodiment of an information processing apparatus according to the present invention;

FIG. 4 shows an example of an internal configuration of a receiver shown in FIG. 3;

FIG. 5 is a sequence diagram for explaining an example of a method for outputting a result of positioning in the information processing system shown in FIG. 3;

FIG. 6 shows a third example embodiment of an information processing apparatus according to the present invention;

FIG. 7 shows an example of an internal configuration of a receiver shown in FIG. 6;

FIG. 8 shows an example of an error in the position of an object that occurs at the time of a change between a Fix and a Float;

FIG. 9 shows an example of an error in the position of an object that occurs in a Fix state;

FIG. 10 shows an example of an internal configuration of the information processing apparatus shown in FIG. 6;

FIG. 11 shows an example of thresholds stored in a database shown in FIG. 10;

FIG. 12 is a sequence diagram for explaining an example of a method for outputting a result of positioning in the information processing system shown in FIG. 6;

FIG. 13 is a flowchart for explaining details of a process in a step S25 described with reference to FIG. 12;

FIG. 14 shows an example of a transformation of a coordinate system;

FIG. 15 is a diagram for explaining an example of a method for calculating a velocity and an acceleration;

FIG. 16 shows an example of an acceleration calculated from a moving distance;

FIG. 17 shows an example of an azimuth calculated from positional information;

FIG. 18 shows an example of an elevation angle calculated from positional information;

FIG. 19 is a diagram for explaining DR, which is another method for obtaining positional information;

FIG. 20 shows a fourth example embodiment of an information processing apparatus according to the present invention;

FIG. 21 shows an example of an internal configuration of a receiver shown in FIG. 20;

FIG. 22 shows an example of an internal configuration of the information processing apparatus shown in FIG. 20;

FIG. 23 is a sequence diagram for explaining an example of a method for outputting a result of positioning in the information processing system shown in FIG. 20;

FIG. 24 shows a fifth example embodiment of an information processing apparatus according to the present invention;

FIG. 25 is a flowchart for explaining an example of a method for outputting a result of positioning in the information processing apparatus shown in FIG. 24;

FIG. 26 shows a sixth example embodiment of an information processing apparatus according to the present invention;

FIG. 27 shows an example of an internal configuration of a receiver shown in FIG. 26;

FIG. 28 is a sequence diagram for explaining an example of a method for outputting a result of positioning in the information processing system shown in FIG. 26;

FIG. 29 shows a seventh example embodiment of an information processing apparatus according to the present invention;

FIG. 30 shows an example of an internal configuration of a receiver shown in FIG. 29;

FIG. 31 shows an example of an internal configuration of the information processing apparatus shown in FIG. 29;

FIG. 32 shows an example of association between velocities, which are movements of a vehicle, and their scores, stored in the database shown in FIG. 31;

FIG. 33 shows an example of association between accelerations, which are movements of the vehicle, and their scores, stored in the database shown in FIG. 31;

FIG. 34 shows an example of association between azimuths, which are movements of the vehicle, and their scores, stored in the database shown in FIG. 31;

FIG. 35 shows an example of association between elevation angles, which are movements of the vehicle, and their scores, stored in the database shown in FIG. 31;

FIG. 36 is a sequence diagram for explaining an example of a method for outputting a result of positioning in the information processing system shown in FIG. 29;

FIG. 37 is a flowchart for explaining details of a process in a step S75 described with reference to FIG. 36;

FIG. 38 shows an eighth example embodiment of an information processing apparatus according to the present invention;

FIG. 39 shows an example of an internal configuration of a receiver shown in FIG. 38;

FIG. 40 shows an example of an internal configuration of the information processing apparatus shown in FIG. 38;

FIG. 41 shows an example of weighting values stored in a database shown in FIG. 40;

FIG. 42 is a sequence diagram for explaining an example of a method for outputting a result of positioning in the information processing system shown in FIG. 38; and

FIG. 43 is a flowchart for explaining details of a process in a step S95 described with reference to FIG. 42.

### DESCRIPTION OF EMBODIMENTS

Example embodiments according to the present invention will be described hereinafter with reference to the drawings.

### First Example Embodiment

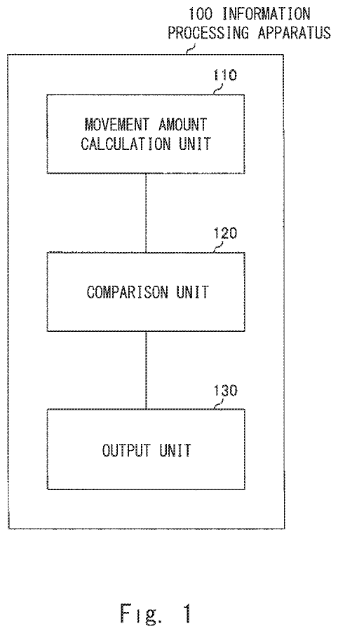

FIG. 1 shows a first example embodiment of an information processing apparatus according to the present invention. As shown in FIG. 1, an information processing apparatus 100 according to this example embodiment includes a movement amount calculation unit 110, a comparison unit 120, and an output unit 130. Note that FIG. 1 shows an example of main components related to this example embodiment among the components included in the information processing apparatus 100 according to this example embodiment.

The movement amount calculation unit 110 calculates the movement of an object based on positional information indicating the position of the object calculated by satellite positioning.

The comparison unit 120 compares the movement calculated by the movement amount calculation unit 110 with a predetermined threshold.

The output unit 130 outputs a result of the comparison made in the comparison unit 120.

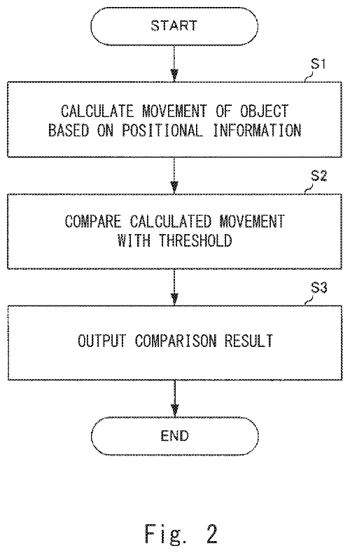

A method for outputting a result of positioning in the information processing apparatus 100 shown in FIG. 1 will be described hereinafter. FIG. 2 is a flowchart for explaining an example of a method for outputting a result of positioning in the information processing apparatus 100 shown in FIG. 1.

Firstly, the movement amount calculation unit 110 calculates the movement of an object based on positional information indicating the position of the object (step S1). Next, the comparison unit 120 compares the movement calculated by the movement amount calculation unit 110 with a predetermined threshold (step S2). Then, the output unit 130 outputs a result of the comparison made in the comparison unit 120 (step S3).

As described above, the information processing apparatus 100 according to this example embodiment outputs the result of the comparison between the movement of the object calculated based on the positional information indicating the position of the object calculated by the satellite positioning and the predetermined threshold. Therefore, it is possible to determine the reliability of the result of the satellite positioning more accurately.

### Second Example Embodiment

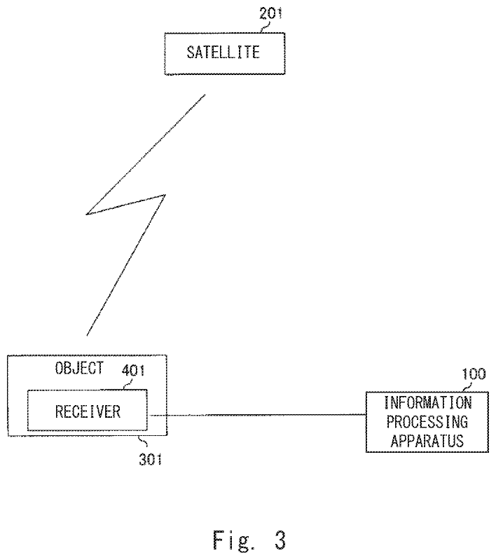

FIG. 3 shows a second example embodiment of an information processing apparatus according to the present invention. This example embodiment is an example embodiment in which the information processing apparatus 100 shown in FIG. 1 is applied to an information processing system. As shown in FIG. 3, this example embodiment includes an information processing apparatus 100, a satellite 201, and an object 301.

The information processing apparatus 100 is the same as that according to the first example embodiment. A receiver 401 is disposed in the object 301. The satellite 201 performs satellite positioning.

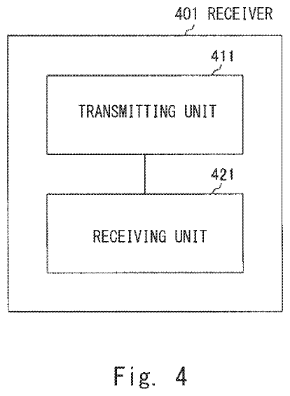

FIG. 4 shows an example of an internal configuration of the receiver 401 shown in FIG. 3. As shown in FIG. 4, the receiver 401 shown in FIG. 3 includes a transmitting unit 411 and a receiving unit 421. Note that FIG. 4 shows an example of main components related to this example embodiment among the components included in the receiver 401 shown in FIG. 3.

The transmitting unit 411 calculates the position of the object 301 based on data received from the satellite 201. The transmitting unit 411 transmits positional information indicating the calculated position to the information processing apparatus 100. The receiving unit 421 receives data from the satellite 201.

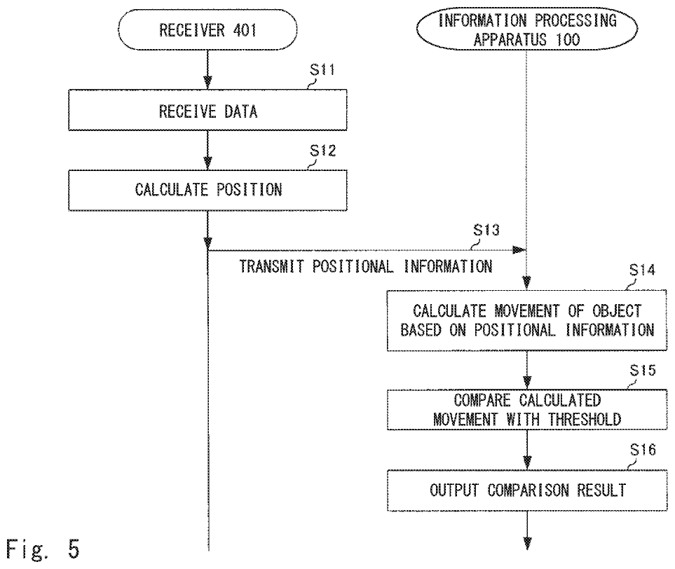

A method for outputting a result of positioning in the information processing system shown in FIG. 3 will be described hereinafter. FIG. 5 is a sequence diagram for explaining an example of a method for outputting a result of positioning in the information processing system shown in FIG. 3.

Firstly, when the receiving unit 421 of the receiver 401 receives data from the satellite 201 (step S11), the transmitting unit 411 calculates the position of the object 301 based on the received data (positioning calculation) (step S12). Next, the transmitting unit 411 transmits positional information indicating the calculated position to the information processing apparatus 100 (step S13).

In response, the movement amount calculation unit 110 calculates the movement of the object based on the positional information transmitted from the transmitting unit 411 (step S14). Next, the comparison unit 120 compares the movement calculated by the movement amount calculation unit 110 with a predetermined threshold (step S15). Then, the output unit 130 outputs a result of the comparison made in the comparison unit 120 (step S16).

Note that the process in the step S12 may be performed by either the receiver 401 or the information processing apparatus 100. That is, the receiver 401 may transmit the data received in the step S11 to the information processing apparatus 100 as observation data and the information processing apparatus 100 may perform positioning calculation based on the observation data transmitted from the receiver 401.

As described above, in the information processing system according to this example embodiment, the transmitting unit 411, which is included in the receiver 401 provided in the object 301, calculates the position of the object 301 based on the data received from the satellite and transmits positional information indicating the calculated position to the information processing apparatus 100. The information processing apparatus 100 outputs a result of a comparison between the movement calculated based on the transmitted positional information and the predetermined threshold. Therefore, it is possible to determine the reliability of the result of the satellite positioning more accurately.

### Third Example Embodiment

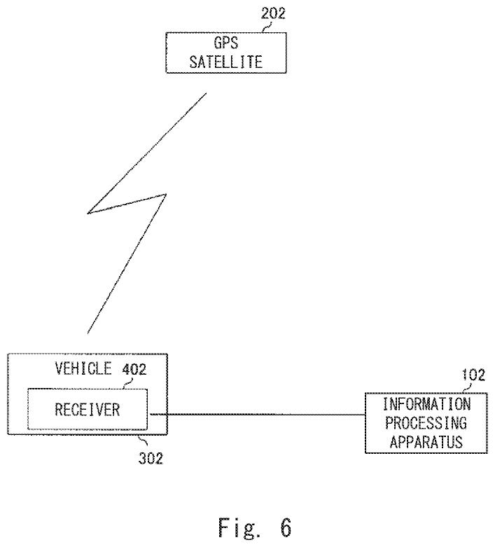

FIG. 6 shows a third example embodiment of an information processing apparatus according to the present invention. As shown in FIG. 6, an information processing system to which the information processing apparatus 102 according to this example embodiment is applied includes the information processing apparatus 102, a GPS satellite 202, and a vehicle 302.

The GPS satellite 202 is an artificial satellite equipped with a typical GPS function and is a satellite for measuring the position of an object by using radio waves. The GPS satellite 202 transmits data including at least transmission time information indicating a time when the GPS satellite 202 transmits the data (i.e., transmits a radio wave) and satellite positional information indicating the position of the GPS satellite 202 to the vehicle 302. Note that although a typical GPS function requires a plurality of satellites, only one satellite is shown in FIG. 6 for convenience of explanation. The same applies to other example embodiments described below.

The vehicle 302 is an object whose position is to be measured. The vehicle 302 includes a receiver 402. The receiver 402 receives data from the GPS satellite 202. The data that the receiver 402 receives from the GPS satellite 202 includes at least transmission time information indicating a time when the GPS satellite 202 transmits the data (i.e., transmits a radio wave) and satellite positional information indicating the position of the GPS satellite 202. Further, the data that the receiver 402 receives from the GPS satellite 202 may include orbit information indicating the orbit of the GPS satellite 202, strength information indicating the strength of the radio wave, etc. The receiver 402 calculates the position of the receiver 402 (the vehicle 302) based on the data received from the GPS satellite 202. The receiver 402 transmits positional information indicating the calculated position to the information processing apparatus 102.

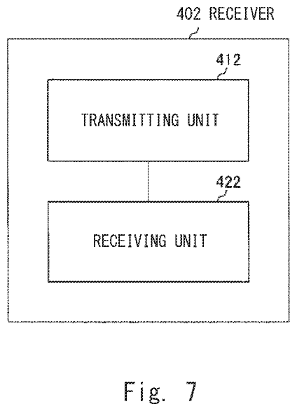

FIG. 7 shows an example of an internal configuration of the receiver 402 shown in FIG. 6. As shown in FIG. 7, the receiver 402 shown in FIG. 6 includes a transmitting unit 412 and a receiving unit 422. Note that FIG. 7 shows an example of main components related to this example embodiment among the components included in the receiver 402 shown in FIG. 6. The transmitting unit 412 performs the above-described process performed by the receiver 402. The receiving unit 422 receives data from the GPS satellite 202.

In general, in satellite positioning using GPS satellites or the like, there are a value “Float” which is an estimated value that is used until a bias expressed by an integer value is determined and a value “Fix” which is the integer value at which the Float is converged.

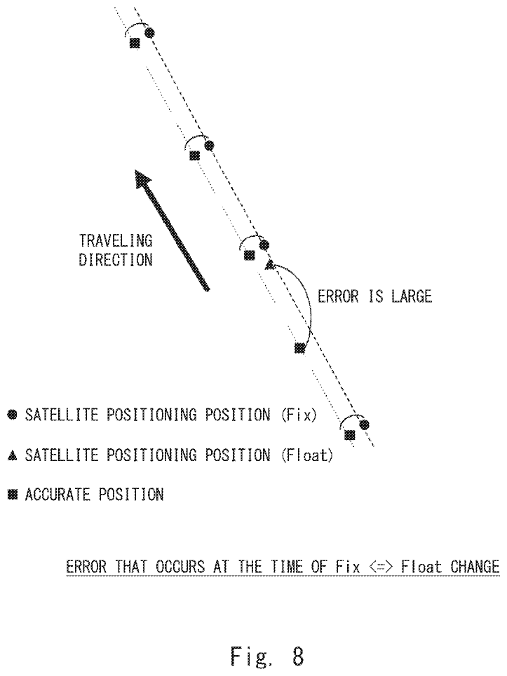

FIG. 8 shows an example of an error in the position of an object that occurs at the time of a change between the Fix and the Float. As shown in FIG. 8, there is a case where there is a large error between a satellite positioning position (Float) and a correct position.

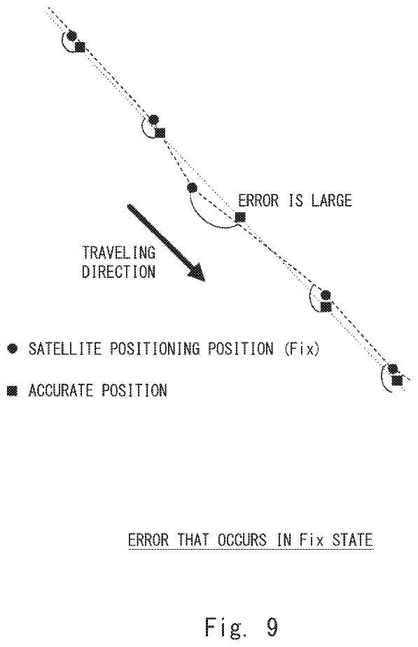

FIG. 9 shows an example of an error in the position of the object that occurs in a Fix state. As shown in FIG. 9, there is a case where there is a large error between a satellite positioning position (Fix) and a correct position.

In the case where, for example, the object is a vehicle, the errors shown in FIGS. 8 and 9 may occur because of such a phenomenon that since it is difficult to measure the position of the vehicle in a tunnel by using satellite positioning, the measured position deviates from the correct position. Further, they may also occur due to such a phenomenon that a position measured by using satellite positioning deviates from the correct position in an urban area where there are a number of high-rise buildings or in a mountain/forest area. Even if such errors occur, an observer cannot recognize the occurrences of those errors.

The information processing apparatus 102 performs a process based on the positional information transmitted from the receiver 402. Note that although FIG. 6 shows a configuration in which the receiver 402 provided in the vehicle 302 is connected to the information processing apparatus 102 in a one-to-one manner, the connection between these entities may be any type of connection as long as the entities can exchange information with each other through, for example, a communication network.

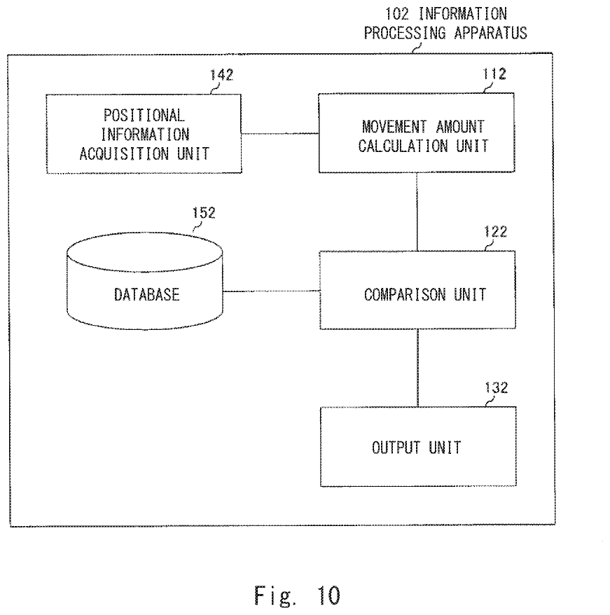

FIG. 10 shows an example of an internal configuration of the information processing apparatus 102 shown in FIG. 6. As shown in FIG. 10, the information processing apparatus 102 shown in FIG. 6 includes a movement amount calculation unit 112, a comparison unit 122, an output unit 132, a positional information acquisition unit 142, and a database 152. Note that FIG. 10 shows an example of main components related to this example embodiment among the components included in the information processing apparatus 102 according to this example embodiment.

The positional information acquisition unit 142 acquires positional information transmitted from the receiver 402.

The movement amount calculation unit 112 calculates the movement of the vehicle 302 based on the positional information acquired by the positional information acquisition unit 142. Specifically, the movement amount calculation unit 112 calculates a moving speed of the vehicle 302 as a movement of the vehicle 302 based on the positional information acquired by the positional information acquisition unit 142. Further, the movement amount calculation unit 112 calculates an acceleration of the vehicle 302 as a movement of the vehicle 302 based on the positional information acquired by the positional information acquisition unit 142. Further, the movement amount calculation unit 112 calculates a moving angle of the vehicle 302 with respect to a direction parallel to the ground surface as a movement of the vehicle 302 based on the positional information acquired by the positional information acquisition unit 142. Further, the movement amount calculation unit 112 calculates a moving angle of the vehicle 302 with respect to a direction perpendicular to the ground surface as a movement of the vehicle 302 based on the positional information acquired by the positional information acquisition unit 142. As described above, the movement amount calculation unit 112 calculates at least one of the moving speed, the acceleration, the moving angle with respect to the direction parallel to the ground surface, and the moving angle with respect to the direction perpendicular to the ground surface as the movement(s) of the vehicle 302 based on the positional information acquired by the positional information acquisition unit 142. Further, the movement amount calculation unit 112 calculates the movement of the vehicle 302 based on a plurality of positional information pieces respectively acquired at predetermined cycles.

The comparison unit 122 compares the movement of the vehicle 302 calculated by the movement amount calculation unit 112 with a predetermined threshold. The predetermined threshold is stored in the database 152 in advance.

The output unit 132 outputs a result of positioning using the positional information of the vehicle 302 based on a result of the comparison made in the comparison unit 122. Note that when the movement calculated by the movement amount calculation unit 112 is within a predetermined range indicated by the threshold stored in the database 152, the output unit 132 outputs the result of positioning using the positional information of the vehicle 302 which has been calculated by the receiver 402 based on the data received from the GPS satellite 202, i.e., the positional information transmitted from the receiver 402. On the other hand, when the movement calculated by the movement amount calculation unit 112 is not within the predetermined range indicated by the threshold stored in the database 152, the output unit 132 outputs a result of positioning using other positional information, different from the result of positioning using the positional information of the vehicle 302 which has been calculated by the receiver 402 based on the data received from the GPS satellite 202, i.e., the positional information transmitted from the receiver 402. Further, the output unit 132 outputs the result of the comparison made in the comparison unit 122. The threshold is stored in the database 152 in advance.

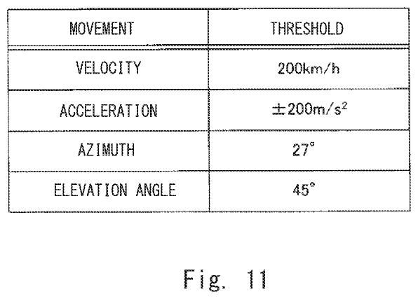

FIG. 11 shows an example of thresholds stored in the database 152 shown in FIG. 10. As shown in FIG. 11, types of movements and their thresholds are stored in an associated manner in the database 152 shown in FIG. 10. As shown in FIG. 11, a threshold “200 km/h” corresponding to a movement “velocity” is stored in the database 152. Further, a threshold “±200 m/s²” corresponding to a movement “acceleration” is stored in the database 152. Further, a threshold “27°” corresponding to a movement “azimuth” is stored in the database 152. Further, a threshold “45°” corresponding to a movement “elevation angle” is stored in the database 152. These thresholds may be statistically calculated in advance as values that measured values are not likely to exceed or fall below when the object performs ordinary movements. Alternatively, these thresholds may be defined in advance as target values at the time of development so as to enhance the performance of the apparatus.

Operations of the output unit 132 that are performed when the thresholds shown in FIG. 11 are used are described. When the velocity of the vehicle 302 calculated by the movement amount calculation unit 112 as the movement of the vehicle 302 is 200 km/h or lower, the output unit 132 outputs a result of positioning using the positional information transmitted from the receiver 402. On the other hand, when the velocity of the vehicle 302 calculated by the movement amount calculation unit 112 as the movement of the vehicle 302 exceeds 200 km/h, the output unit 132 outputs a result of positioning using other positional information different from the positional information transmitted from the receiver 402. Further, when the acceleration of the vehicle 302 calculated by the movement amount calculation unit 112 as the movement of the vehicle 302 is 200 m/s² or lower, the output unit 132 outputs the result of positioning using the positional information transmitted from the receiver 402. On the other hand, when the acceleration of the vehicle 302 calculated by the movement amount calculation unit 112 as the movement of the vehicle 302 exceeds 200 m/s², the output unit 132 outputs the result of positioning using the other positional information different from the positional information transmitted from the receiver 402. Further, when the azimuth of the vehicle 302 calculated by the movement amount calculation unit 112 as the movement of the vehicle 302 is 27° or smaller, the output unit 132 outputs the result of positioning using the positional information transmitted from the receiver 402. On the other hand, when the azimuth of the vehicle 302 calculated by the movement amount calculation unit 112 as the movement of the vehicle 302 exceeds 27°, the output unit 132 outputs the result of positioning using the other positional information different from the positional information transmitted from the receiver 402. Further, when the elevation angle of the vehicle 302 calculated by the movement amount calculation unit 112 as the movement of the vehicle 302 is 45° or lower, the output unit 132 outputs the result of positioning using the positional information transmitted from the receiver 402. On the other hand, when the elevation angle of the vehicle 302 calculated by the movement amount calculation unit 112 as the movement of the vehicle 302 exceeds 45°, the output unit 132 outputs the result of positioning using other positional information different from the positional information transmitted from the receiver 402.

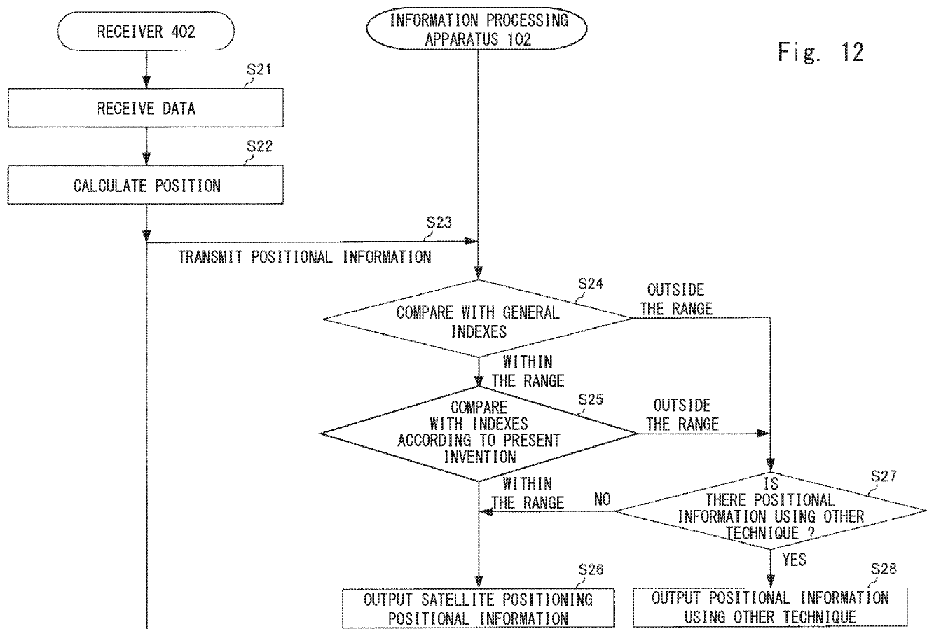

A method for outputting a result of positioning in the information processing system shown in FIG. 6 will be described hereinafter. FIG. 12 is a sequence diagram for explaining an example of a method for outputting a result of positioning in the information processing system shown in FIG. 6.

Firstly, when the receiving unit 422 of the receiver 402 receives data from the GPS satellite 202 (step S21), the transmitting unit 412 calculates the position of the vehicle 302 based on the received data (positioning calculation) (step S22). Next, the transmitting unit 412 transmits positional information indicating the calculated position to the information processing apparatus 102 (step S23). In response, the positional information acquisition unit 142 acquires the positional information transmitted from the transmitting unit 412. Next, the comparison unit 122 compares the current environment with general indexes (step S24). The general indexes indicate the number of satellites (the number of observation satellites) used for the calculation of the positional information by the receiver 402 and an arrangement state of these satellites (DOP: Dilution of Precision). The comparison unit 122 compares these indexes with indexes (thresholds) which are stored in the database 152 in advance and determines whether or not results of the comparisons are within predetermined ranges. A commonly-used process may be used for the above-described process in the step S24.

When the comparison unit 122 determines that the general indexes are within the ranges, it performs comparisons with indexes according to the present invention (step S25). The comparison process in the step S25 will be described hereinafter.

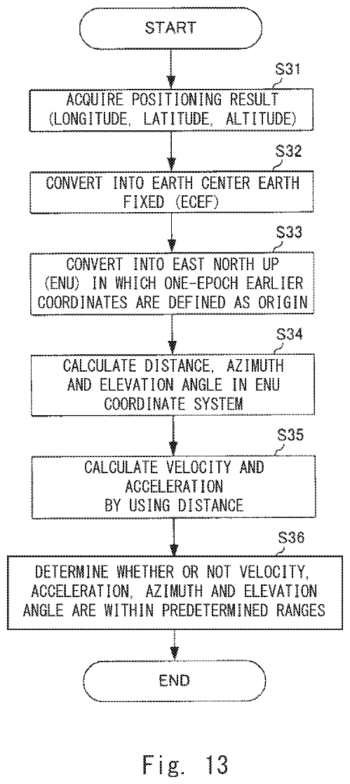

FIG. 13 is a flowchart for explaining details of the process in the step S25 described above with reference to FIG. 12. Firstly, the positional information acquisition unit 142 acquires results of positioning in regard to the latitude, the longitude, and the altitude (step S31). Next, the movement amount calculation unit 112 converts the acquired parameters in regard to the latitude, the longitude, and the altitude into earth-centered coordinates (ECEF: Earth Center Earth Fixed) (step S32). Then, the movement amount calculation unit 112 converts the converted coordinates into a horizontal coordinate system (ENU: East North Up) in which one-epoch earlier coordinates are defined as the origin (step S33). Note that one epoch is a time period in which a plurality of positional information pieces are acquired. In this example, one epoch is 50 ms.

The movement amount calculation unit 112 calculates a distance the vehicle 302 has moved, and an azimuth and an elevation angle of the movement in the ENU coordinate system (step S34). Further, the movement amount calculation unit 112 calculates the velocity and the acceleration of the vehicle 302 based on the calculated distance (step S35). The comparison unit 122 compares the velocity, the acceleration, the azimuth, and the elevation angle calculated by the movement amount calculation unit 112 with thresholds stored in the database 152, and thereby determines whether or not they are within predetermined ranges (step S36).

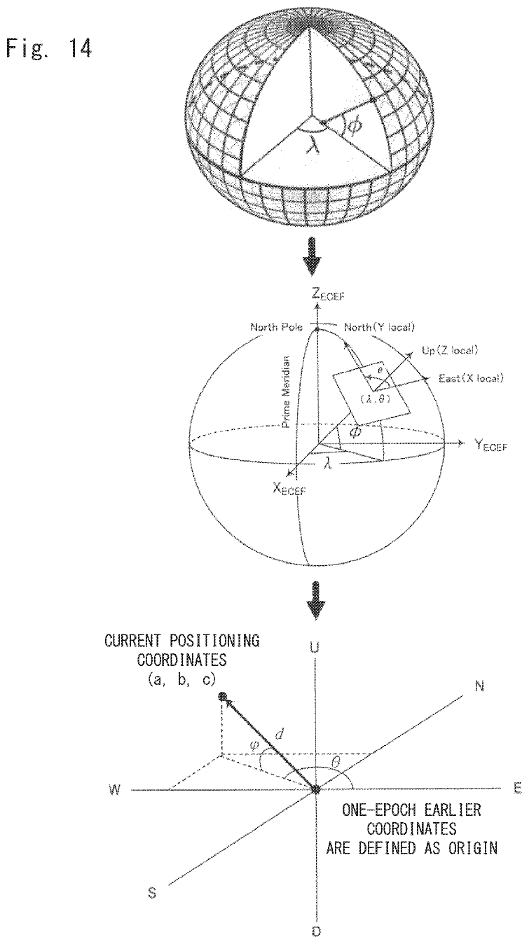

FIG. 14 shows an example of a conversion of coordinate systems. As shown in FIG. 14, the earth-centered coordinates converted from the positional information (the latitude, the longitude, and the altitude) acquired from the receiver 402 are converted into the ENU coordinate system (a middle part in FIG. 14). For the converted ENU coordinates, the movement amount calculation unit 112 calculates the distance, the azimuth of the movement, and the elevation angle of the movement while defining the one-epoch earlier coordinates as the origin. The azimuth is a moving angle of the vehicle 302 with respect to the direction parallel to the ground surface. The elevation angle is a moving angle of the vehicle 302 with respect to the direction perpendicular to the ground surface.

In the coordinates (a, b, c) shown in FIG. 14, the distance, the azimuth, and the elevation angle from the one-epoch earlier coordinates are calculated by using the below-shown (Expression 1) to (Expression 3).

The distance d is calculated by using the below-shown expression.

[Expression 1]

d=\sqrt{a²+b²+c²} (Expression 1)

The azimuth θ (an angle from the eastward direction) is calculated by using the below-shown expression.

$$\begin{matrix}[ Expression 2 ] & \\ θ = {tan}^{- 1} ( \frac{b}{a} ) [ - π ≦ θ ≦ π ] & ( Expression 2 )\end{matrix}$$

The elevation angle Φ (a vertical angle from the horizontal plane) is calculated by using the below-shown expression.

$$\begin{matrix}[ Expression 3 ] & \\ ϕ = {tan}^{- 1} ( \frac{c}{\sqrt{{a}^{2} + {b}^{2}}} ) [ - \frac{π}{2} ≦ ϕ ≦ \frac{π}{2} ] & ( Expression 3 )\end{matrix}$$

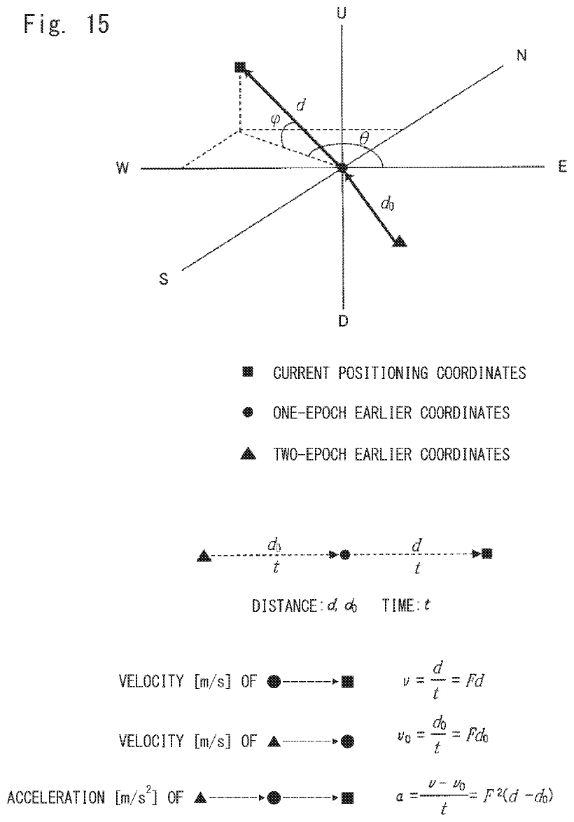

FIG. 15 is a diagram for explaining an example of a method of calculating a velocity and an acceleration. As shown in FIG. 15, the velocity is calculated from the distance d and the unit time for one epoch. Further, the acceleration is calculated by using the calculated velocity.

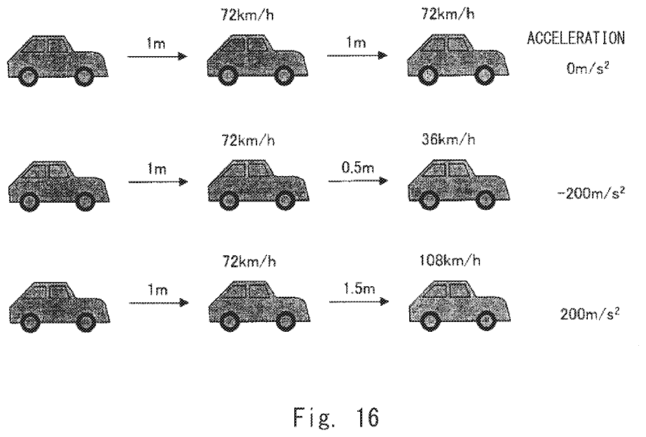

FIG. 16 shows an example of an acceleration calculated from the moving distance. In the example shown in FIG. 16, the period of one epoch is 50 ms. As shown in FIG. 16, in an example in an upper part, since the vehicle moves 1 m in 1 epoch, its velocity is 72 km/h. Further, since the vehicle also moves 1 m in the next 1 epoch, its acceleration is 0 m/s². Meanwhile, in an example in a middle part, since the vehicle moves 1 m in 1 epoch, its velocity is 72 km/h. Further, since the vehicle moves 0.5 m in the next 1 epoch, its velocity becomes 36 km/h and its acceleration is −200 m/s². Further, in an example in a lower part, since the vehicle moves 1 m in 1 epoch, its velocity is 72 km/h. Further, since the vehicle moves 1.5 m in the next 1 epoch, its velocity becomes 108 km/h and its acceleration is 200 m/s².

As described above, the velocity and the acceleration are calculated from the positional information. By doing so, it is possible to determine that the positional information acquired by the satellite positioning is inappropriate because the fact that the velocity has changed from 72 km/h to 36 km/h or to 108 km/h in 50 ms and an acceleration of ±200 m/s² has occurred is unrealistic.

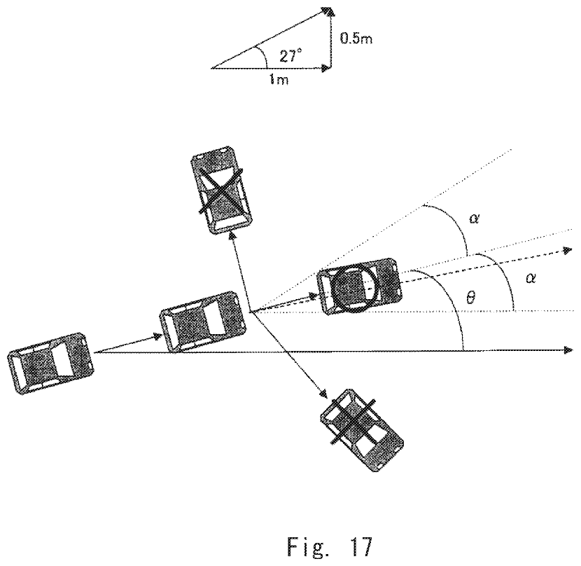

FIG. 17 shows an example of an azimuth calculated from positional information. As shown in FIG. 17, when the vehicle 302 has moved 1 m in 1 epoch and it has horizontally moved by 0.5 m, it means that the azimuth has changed by 27°. When the change in the azimuth is large, it can be determined that the positional information acquired by the satellite positioning is inappropriate.

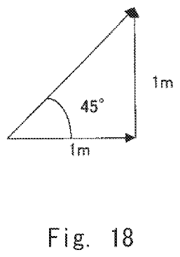

FIG. 18 shows an example of an elevation angle calculated from positional information. As shown in FIG. 18, when the vehicle 302 moves 1 m at 1 epoch and it has vertically moved (altitude) by 1 m, it means that the elevation angle has changed by 45°. When the change in the elevation angle is large, it can be determined that the positional information acquired by the satellite positioning is inappropriate.

When it is determined that the comparisons of the indexes according to the present invention are within the predetermined ranges in the step S25, the output unit 132 outputs satellite positioning positional information (step S26). Note that the satellite positioning positional information is the positional information transmitted from the receiver 402.

On the other hand, when it is determined that the measured values are outside the predetermined ranges in the step S24 or when it is determined that the measured values are outside the predetermined ranges in the step S25, the output unit 132 determines whether or not there is positional information using other techniques (step S27). When the output unit 132 determines that there is no positional information using other techniques, it performs a process in a step S26. On the other hand, when the output unit 132 determines that there is positional information using other techniques, it outputs the positional information using the other technique (step S28).

Note that the other technique may be any technique by which positional information can be acquired. The same applies to other example embodiments described below. An example of the other techniques will be described hereinafter.

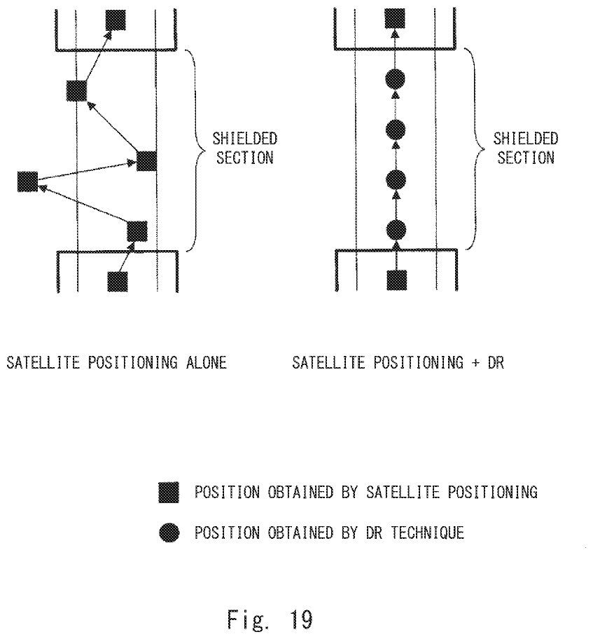

FIG. 19 is a diagram for explaining DR (Dead Reckoning: autonomous navigation) which is one of the other techniques for acquiring positional information. In a place where there are many shielding objects such as a tunnel, an underground parking lot, and a place where high-rise buildings stand side by side, signals transmitted from satellites to vehicles are interrupted, thus making the satellite positioning impossible. Therefore, the movement and the position of the vehicle are calculated based on information detected by various sensors such as an acceleration sensor, a gyro sensor, etc. provided in the vehicle. As shown in FIG. 19, in a shielded section such as a tunnel, there is a possibility that a position calculated by using satellite positioning deviates from the correct position. Therefore, in the shielded section, the position is calculated by using a DR technique and its positional information is used.

Note that the process in the step S22 may be performed by either the receiver 402 or the information processing apparatus 102. That is, the receiver 402 may transmit the data received in the step S21 to the information processing apparatus 102 as observation data and the information processing apparatus 102 may perform positioning calculation based on the observation data transmitted from the receiver 402.

As described above, in the information processing system according to this example embodiment, the transmitting unit 412, which is included in the receiver 402 provided in the vehicle 302, calculates the position of the vehicle 302 based on the data received from the satellite and transmits positional information indicating the calculated position to the information processing apparatus 102. The information processing apparatus 102 calculates the velocity and the acceleration of the object, and the azimuth and the elevation angle of the movement based on the transmitted positional information. Then, when the calculated values are within predetermined ranges, the information processing apparatus 102 outputs a result of positioning using the transmitted positional information. On the other hand, when the calculated values are outside the predetermined ranges, the information processing apparatus 102 outputs a result of positioning using other techniques. Therefore, it is possible to determine the reliability of a result of the satellite positioning more accurately and thereby to output a reliable positioning result.

### Fourth Example Embodiment

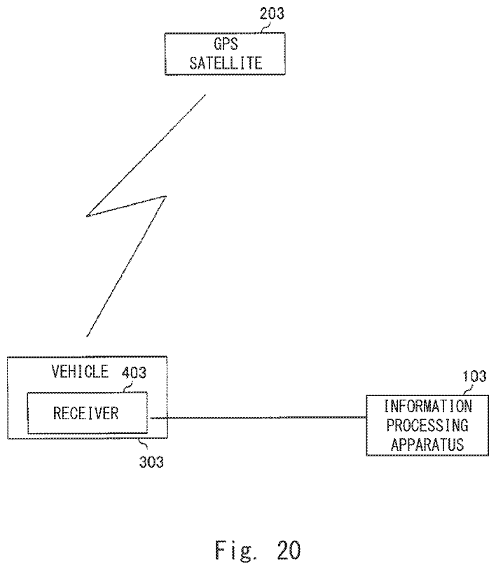

FIG. 20 shows a fourth example embodiment of an information processing apparatus according to the present invention. As shown in FIG. 20, an information processing system to which an information processing apparatus 103 according to this example embodiment is applied includes the information processing apparatus 103, a GPS satellite 203, and a vehicle 303.

The GPS satellite 203 is an artificial satellite equipped with a typical GPS function and is a satellite for measuring the position of an object by using radio waves. The GPS satellite 203 transmits data including at least transmission time information indicating a time when the GPS satellite 203 transmits the data (i.e., transmits a radio wave) and satellite positional information indicating the position of the GPS satellite 203 to the vehicle 303.

The vehicle 303 is an object whose position is to be measured. The vehicle 303 includes a receiver 403. The receiver 403 receives data from the GPS satellite 203. The data that the receiver 403 receives from the GPS satellite 203 includes at least transmission time information indicating a time when the GPS satellite 203 transmits the data (i.e., transmits a radio wave) and satellite positional information indicating the position of the GPS satellite 203. Further, the data that the receiver 403 receives from the GPS satellite 203 may include orbit information indicating the orbit of the GPS satellite 203, strength information indicating the strength of the radio wave, etc. The receiver 403 calculates the position of the receiver 403 (the vehicle 303) based on the data received from the GPS satellite 203. The receiver 403 transmits positional information indicating the calculated position to the information processing apparatus 103.

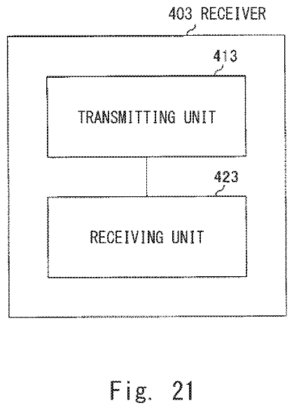

FIG. 21 shows an example of an internal configuration of the receiver 403 shown in FIG. 20. As shown in FIG. 21, the receiver 403 shown in FIG. 20 includes a transmitting unit 413 and a receiving unit 423. Note that FIG. 21 shows an example of main components related to this example embodiment among the components included in the receiver 403 shown in FIG. 20. The transmitting unit 413 performs the above-described process performed by the receiver 403. The receiving unit 423 receives data from the GPS satellite 203.

The information processing apparatus 103 performs a process based on the positional information transmitted from the receiver 403. Note that although FIG. 20 shows a configuration in which the receiver 403 provided in the vehicle 303 is connected with the information processing apparatus 103 in a one-to-one manner, the connection between these entities may be any type of connection as long as the entities can exchange information with each other through, for example, a communication network.

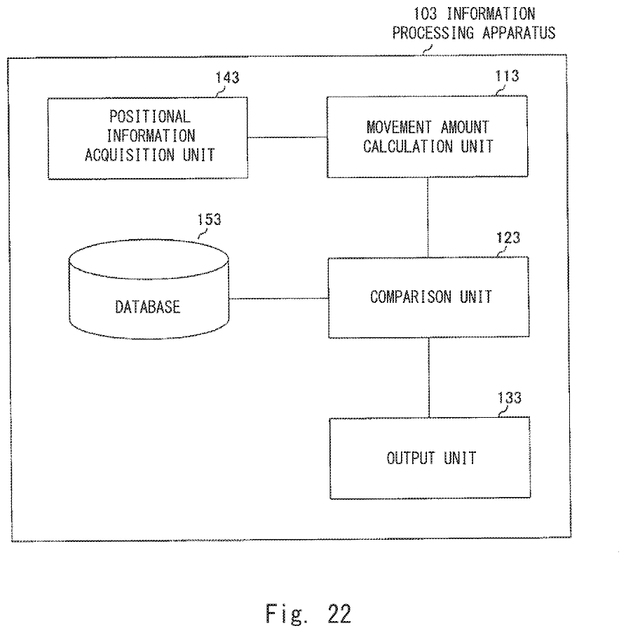

FIG. 22 shows an example of an internal configuration of the information processing apparatus 103 shown in FIG. 20. As shown in FIG. 22, the information processing apparatus 103 shown in FIG. 20 includes a movement amount calculation unit 113, a comparison unit 123, an output unit 133, a positional information acquisition unit 143, and a database 153. Note that FIG. 22 shows an example of main components related to this example embodiment among the components included in the information processing apparatus 103 according to this example embodiment.

The positional information acquisition unit 143 acquires positional information transmitted from the receiver 403.

The movement amount calculation unit 113 calculates the movement of the vehicle 303 based on the positional information acquired by the positional information acquisition unit 143. Specifically, the movement amount calculation unit 113 calculates a moving speed of the vehicle 303 as a movement of the vehicle 303 based on the positional information acquired by the positional information acquisition unit 143. Further, the movement amount calculation unit 113 calculates an acceleration of the vehicle 303 as a movement of the vehicle 303 based on the positional information acquired by the positional information acquisition unit 143. Further, the movement amount calculation unit 113 calculates a moving angle of the vehicle 302 with respect to a direction parallel to the ground surface as a movement of the vehicle 303 based on the positional information acquired by the positional information acquisition unit 143. Further, the movement amount calculation unit 113 calculates a moving angle of the vehicle 303 with respect to a direction perpendicular to the ground surface as a movement of the vehicle 303 based on the positional information acquired by the positional information acquisition unit 143. Further, the movement amount calculation unit 113 calculates the movement of the vehicle 303 based on a plurality of positional information pieces respectively acquired at predetermined cycles.

The comparison unit 123 compares the movement of the vehicle 303 calculated by the movement amount calculation unit 113 with a predetermined threshold. The predetermined threshold is stored in the database 153 in advance.

The output unit 133 outputs a result of positioning using the positional information of the vehicle 303 based on a result of the comparison made in the comparison unit 123. Note that when the movement calculated by the movement amount calculation unit 113 is within a predetermined range indicated by the threshold stored in the database 153, the output unit 133 outputs the result of positioning using the positional information of the vehicle 303 which has been calculated by the receiver 403 based on the data received from the GPS satellite 203, i.e., the positional information transmitted from the receiver 403. On the other hand, when the movement calculated by the movement amount calculation unit 113 is not within the predetermined range indicated by the threshold stored in the database 153, the output unit 133 outputs a result of positioning using other positional information, different from the result of positioning using the positional information of the vehicle 303 which has been calculated by the receiver 403 based on the data received from the GPS satellite 203, i.e., the positional information transmitted from the receiver 403. Further, the output unit 133 outputs the result of the comparison made in the comparison unit 123.

The threshold is stored in the database 153 in advance. The thresholds stored in the database 153 are the same as those in the third example embodiment shown in FIG. 11.

Operations of the output unit 133 that are performed when the thresholds shown in FIG. 11 are used are described. When the velocity of the vehicle 303 calculated by the movement amount calculation unit 113 as the movement of the vehicle 303 is 200 km/h or lower, the output unit 133 outputs a result of positioning using the positional information transmitted from the receiver 403.

On the other hand, when the velocity of the vehicle 303 calculated by the movement amount calculation unit 113 as the movement of the vehicle 303 exceeds 200 km/h, the output unit 133 outputs a result of positioning using other positional information different from the positional information transmitted from the receiver 403. Further, when the acceleration of the vehicle 303 calculated by the movement amount calculation unit 113 as the movement of the vehicle 303 is 200 m/s² or lower, the output unit 133 outputs the result of positioning using the positional information transmitted from the receiver 403. On the other hand, when the acceleration of the vehicle 303 calculated by the movement amount calculation unit 113 as the movement of the vehicle 303 exceeds 200 m/s², the output unit 133 outputs the result of positioning using the other positional information different from the positional information transmitted from the receiver 403. Further, when the azimuth of the vehicle 303 calculated by the movement amount calculation unit 113 as the movement of the vehicle 303 is 27° or smaller, the output unit 133 outputs the result of positioning using the positional information transmitted from the receiver 403. On the other hand, when the azimuth of the vehicle 303 calculated by the movement amount calculation unit 113 as the movement of the vehicle 303 exceeds 27°, the output unit 133 outputs the result of positioning using the other positional information different from the positional information transmitted from the receiver 403. Further, when the elevation angle of the vehicle 303 calculated by the movement amount calculation unit 113 as the movement of the vehicle 303 is 45° or lower, the output unit 133 outputs the result of positioning using the positional information transmitted from the receiver 403. On the other hand, when the elevation angle of the vehicle 303 calculated by the movement amount calculation unit 113 as the movement of the vehicle 303 exceeds 45°, the output unit 133 outputs the result of positioning using other positional information different from the positional information transmitted from the receiver 403.

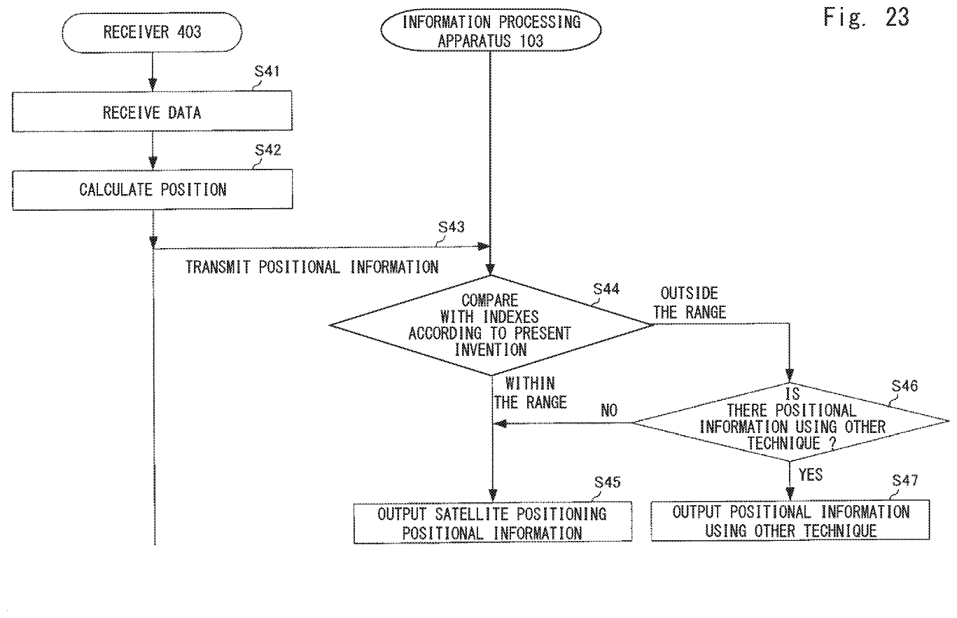

A method for outputting a result of positioning in the information processing system shown in FIG. 20 will be described hereinafter. FIG. 23 is a sequence diagram for explaining an example of a method for outputting a result of positioning in the information processing system shown in FIG. 20.

Firstly, when the receiving unit 423 of the receiver 403 receives data from the GPS satellite 203 (step S41), the transmitting unit 413 calculates the position of the vehicle 303 based on the received data (positioning calculation) (step S42). Next, the transmitting unit 413 transmits positional information indicating the calculated position to the information processing apparatus 103 (step S43).

In response, the positional information acquisition unit 143 acquires the positional information transmitted from the transmitting unit 413. Next, the movement amount calculation unit 113 and the comparison unit 123 make comparisons with the indexes according to the present invention (step S44). This comparison process is the same as the process in the third example embodiment described above with reference to the flowchart shown in FIG. 13.

When it is determined that the comparisons of the indexes according to the present invention are within the predetermined ranges in the step S44, the output unit 133 outputs satellite positioning positional information (step S45). Note that the satellite positioning positional information is the positional information transmitted from the receiver 403.

On the other hand, when it is determined that the measured values are outside the predetermined ranges in the step S44, the output unit 133 determines whether or not there is positional information using other techniques (step S46). When the output unit 133 determines that there is no positional information using other techniques, it performs a process in a step S45. On the other hand, when the output unit 133 determines that there is positional information using other techniques, it outputs the positional information using the other technique (step S47). Note that the other technique may be the same as that described in the third example embodiment.

Note that the process in the step S42 may be performed by either the receiver 403 or the information processing apparatus 103. That is, the receiver 403 may transmit the data received in the step S41 to the information processing apparatus 103 as observation data and the information processing apparatus 103 may perform positioning calculation based on the observation data transmitted from the receiver 403.

As described above, in the information processing system according to this example embodiment, the transmitting unit 413, which is included in the receiver 403 provided in the vehicle 303, calculates the position of the vehicle 303 based on the data received from the satellite, and transmits positional information indicating the calculated position to the information processing apparatus 103. The information processing apparatus 103 calculates the velocity and the acceleration of the object, and the azimuth and the elevation angle of the movement based on the transmitted positional information. Then, when the calculated values are within predetermined ranges, the information processing apparatus 103 outputs a result of positioning using the transmitted positional information. On the other hand, when the calculated values are outside the predetermined ranges, the information processing apparatus 103 outputs a result of positioning using other techniques. Therefore, it is possible to determine the reliability of a result of the satellite positioning more accurately and thereby to output a reliable positioning result.

### Fifth Example Embodiment

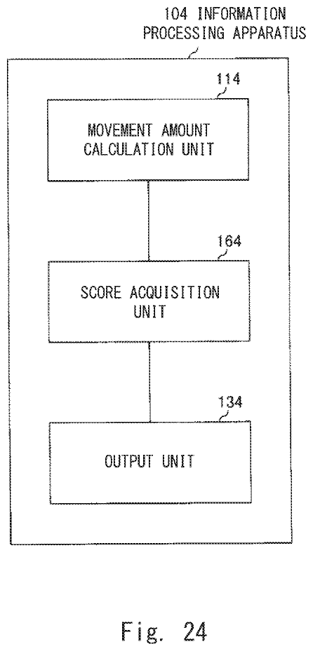

FIG. 24 shows a fifth example embodiment of an information processing apparatus according to the present invention. As shown in FIG. 24, an information processing apparatus 104 according to this example embodiment includes a movement amount calculation unit 114, a score acquisition unit 164, and an output unit 134. Note that FIG. 24 shows an example of main components related to this example embodiment among the components included in the information processing apparatus 104 according to this example embodiment.

The movement amount calculation unit 114 calculates the movement of an object based on positional information indicating the position of the object calculated by satellite positioning.

The score acquisition unit 164 acquires a score corresponding to the movement calculated by the movement amount calculation unit 114.

The output unit 134 outputs the score acquired by the score acquisition unit 164.

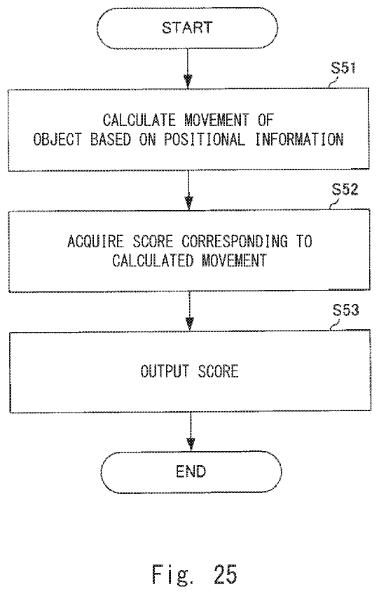

A method for outputting a result of positioning in the information processing apparatus 104 shown in FIG. 24 will be described below. FIG. 25 is a flowchart for explaining an example of a method for outputting a result of positioning in the information processing apparatus 104 shown in FIG. 24.

Firstly, the movement amount calculation unit 114 calculates the movement of the object based on positional information indicating the position of the object (step S51). Next, the score acquisition unit 164 acquires a score corresponding to the movement calculated by the movement amount calculation unit 114 (step S52). Then, the output unit 134 outputs the score acquired by the score acquisition unit 164 (step S53).

As described above, the information processing apparatus 104 according to this example embodiment acquires a score corresponding to the movement of the object calculated based on positional information indicating the position of the object calculated by satellite positioning, and outputs the acquired score. Therefore, it is possible to determine the reliability of the result of the satellite positioning more accurately.

### Sixth Example Embodiment

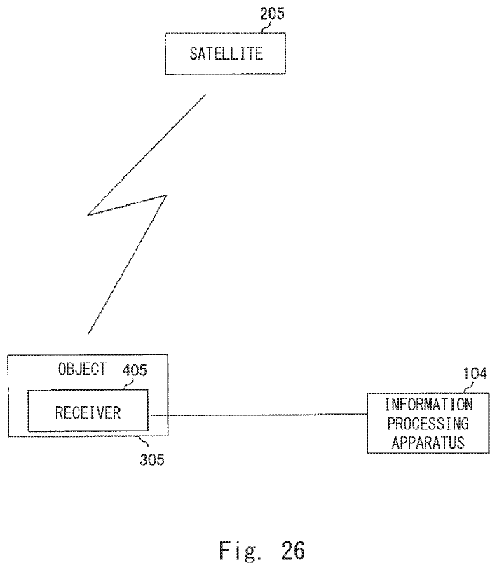

FIG. 26 shows a sixth example embodiment of an information processing apparatus according to the present invention. This example embodiment is an example embodiment in which the information processing apparatus 104 shown in FIG. 24 is applied to an information processing system. As shown in FIG. 26, this example embodiment includes the information processing apparatus 104, a satellite 205, and an object 305.

The information processing apparatus 104 is the same as that in the fifth example embodiment. The object 305 includes a receiver 405. The satellite 205 performs satellite positioning.

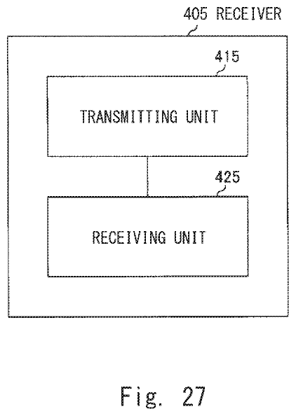

FIG. 27 shows an example of an internal configuration of the receiver 405 shown in FIG. 26. As shown in FIG. 27, the receiver 405 shown in FIG. 26 includes a transmitting unit 415 and a receiving unit 425. Note that FIG. 27 shows an example of main components related to this example embodiment among the components included in the receiver 405 shown in FIG. 26.

The transmitting unit 415 calculates the position of the object 305 based on data received from the satellite 205. The transmitting unit 104 transmits positional information indicating the calculated position to the information processing apparatus 415. The receiving unit 425 receives data from the satellite 205.

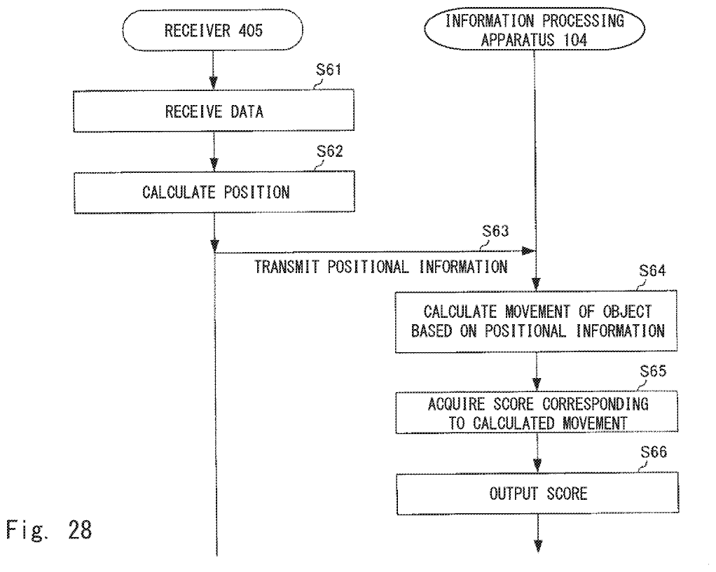

A method for outputting a result of positioning in the information processing system shown in FIG. 26 will be described hereinafter. FIG. 28 is a sequence diagram for explaining an example of a method for outputting a result of positioning in the information processing system shown in FIG. 26.

Firstly, when the receiving unit 425 of the receiver 405 receives data from the satellite 205 (step S61), the transmitting unit 415 calculates the position of the object 305 based on the received data (positioning calculation) (step S62). Next, the transmitting unit 104 transmits positional information indicating the calculated position to the information processing apparatus 415 (step S63).

In response, the movement amount calculation unit 114 calculates the movement of the object based on the positional information transmitted from the transmitting unit 415 (step S64). Next, the score acquisition unit 164 acquires a score corresponding to the movement calculated by the movement amount calculation unit 114 (step S65). Then, the output unit 134 outputs the score acquired by the score acquisition unit 164 (step S66).

Note that the process in the step S62 may be performed by either the receiver 405 or the information processing apparatus 104. That is, the receiver 405 may transmit the data received in the step S61 to the information processing apparatus 104 as observation data and the information processing apparatus 104 may perform positioning calculation based on the observation data transmitted from the receiver 405.

As described above, in the information processing system according to this example embodiment, the transmitting unit 415, which is included in the receiver 405 provided in the object 305, calculates the position of the object 305 based on the data received from the satellite and transmits positional information indicating the calculated position to the information processing apparatus 104. The information processing apparatus 104 acquires a score corresponding to the movement calculated based on the transmitted positional information and outputs the acquired score. Therefore, it is possible to determine the reliability of the result of the satellite positioning more accurately.

### Seventh Example Embodiment

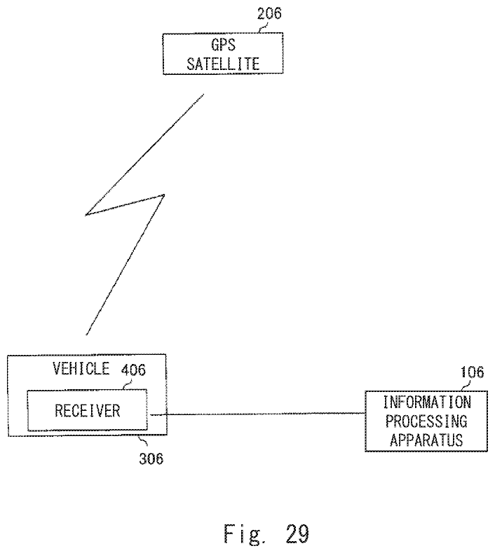

FIG. 29 shows a seventh example embodiment of an information processing apparatus according to the present invention. As shown in FIG. 29, an information processing system to which the information processing apparatus 106 according to this example embodiment is applied includes the information processing apparatus 106, a GPS satellite 206, and a vehicle 306.

The GPS satellite 206 is an artificial satellite equipped with a typical GPS function and is a satellite for measuring the position of an object by using radio waves. The GPS satellite 206 transmits data including at least transmission time information indicating a time when the GPS satellite 206 transmits the data (i.e., transmits a radio wave) and satellite positional information indicating the position of the GPS satellite 206 to the vehicle 306.

The vehicle 306 is an object whose position is to be measured. The vehicle 306 includes a receiver 406. The receiver 406 receives data from the GPS satellite 206. The data that the receiver 406 receives from the GPS satellite 206 includes at least transmission time information indicating a time when the GPS satellite 206 transmits the data (i.e., transmits a radio wave) and satellite positional information indicating the position of the GPS satellite 206. Further, the data that the receiver 406 receives from the GPS satellite 206 may include orbit information indicating the orbit of the GPS satellite 206, strength information indicating the strength of the radio wave, etc. The receiver 406 calculates the position of the receiver 406 (the vehicle 306) based on the data received from the GPS satellite 206. The receiver 406 transmits positional information indicating the calculated position to the information processing apparatus 106.

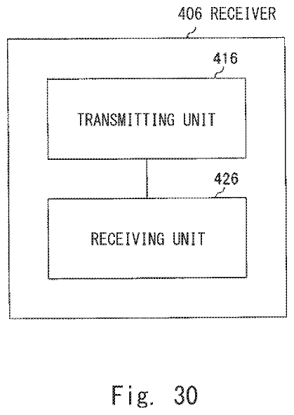

FIG. 30 shows an example of an internal configuration of the receiver 406 shown in FIG. 29. As shown in FIG. 30, the receiver 406 shown in FIG. 29 includes a transmitting unit 416 and a receiving unit 426. Note that FIG. 30 shows an example of main components related to this example embodiment among the components included in the receiver 406 shown in FIG. 29. The transmitting unit 416 performs the above-described process performed by the receiver 406. The receiving unit 426 receives data from the GPS satellite 206.

The information processing apparatus 106 performs a process based on the positional information transmitted from the receiver 406. Note that although FIG. 29 shows a configuration in which the receiver 406 provided in the vehicle 306 is connected with the information processing apparatus 106 in a one-to-one manner, the connection between these entities may be any type of connection as long as the entities can exchange information with each other through, for example, a communication network.

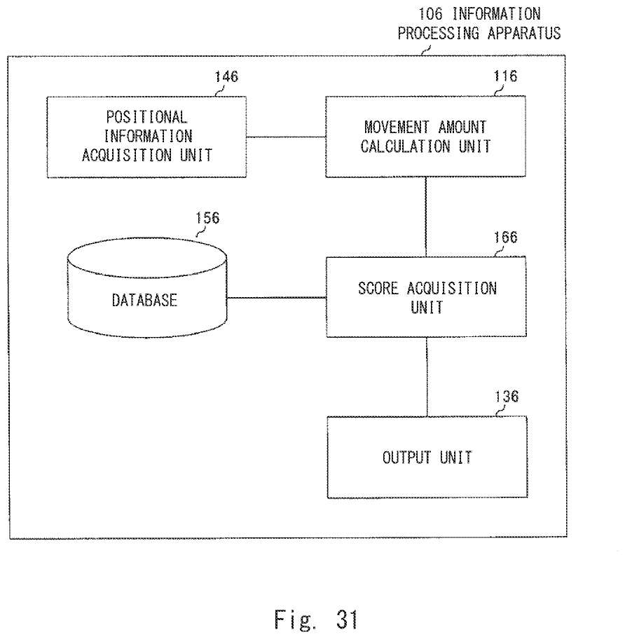

FIG. 31 shows an example of an internal configuration of the information processing apparatus 106 shown in FIG. 29. As shown in FIG. 31, the information processing apparatus 106 shown in FIG. 29 includes a movement amount calculation unit 116, a score acquisition unit 166, an output unit 136, a positional information acquisition unit 146, and a database 156. Note that FIG. 31 shows an example of main components related to this example embodiment among the components included in the information processing apparatus 106 according to this example embodiment.

The positional information acquisition unit 146 acquires positional information transmitted from the receiver 406.

The movement amount calculation unit 116 calculates a movement of the vehicle 306 based on the positional information acquired by the positional information acquisition unit 146. Specifically, the movement amount calculation unit 116 calculates a moving speed of the vehicle 306 as a movement of the vehicle 306 based on the positional information acquired by the positional information acquisition unit 146. Further, the movement amount calculation unit 116 calculates an acceleration of the vehicle 306 as a movement of the vehicle 306 based on the positional information acquired by the positional information acquisition unit 146. Further, the movement amount calculation unit 116 calculates a moving angle of the vehicle 306 with respect to a direction parallel to the ground surface as a movement of the vehicle 306 based on the positional information acquired by the positional information acquisition unit 146. Further, the movement amount calculation unit 116 calculates a moving angle of the vehicle 306 with respect to a direction perpendicular to the ground surface as a movement of the vehicle 306 based on the positional information acquired by the positional information acquisition unit 146. Further, the movement amount calculation unit 116 calculates the movement of the vehicle 306 based on a plurality of positional information pieces respectively acquired at predetermined cycles.

The score acquisition unit 166 acquires a score corresponding to the movement calculated by the movement amount calculation unit 116. Note that the score acquisition unit 166 acquires, from the database 156, a score that is stored in the database 156 in association with the movement calculated by the movement amount calculation unit 116.

The output unit 136 outputs a result of positioning using positional information of the vehicle 306 based on the score acquired by the score acquisition unit 166. Note that when the score acquired by the score acquisition unit 166 is equal to or lower than a predetermined threshold, the output unit 136 outputs the result of positioning using the positional information of the vehicle 306 which has been calculated by the receiver 406 based on the data received from the GPS satellite 206, i.e., the positional information transmitted from the receiver 406. On the other hand, when the score acquired by the score acquisition unit 166 exceeds the predetermined threshold, the output unit 136 outputs a result of positioning using other positional information, different from the result of positioning using the positional information of the vehicle 306 which has been calculated by the receiver 406 based on the data received from the GPS satellite 206, i.e., the positional information transmitted from the receiver 406. Further, the output unit 136 outputs the score acquired by the score acquisition unit 166. Movements of the vehicle 306 and their scores are stored in an associated manner in the database 156 in advance.

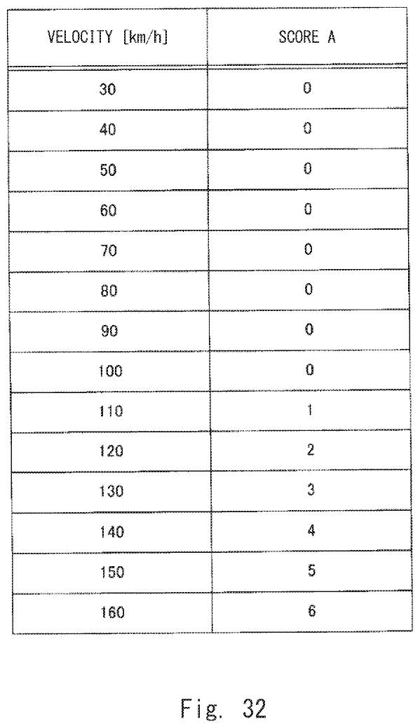

FIG. 32 shows an example of association between velocities, which are movements of the vehicle 306, and their scores, stored in the database 156 shown in FIG. 31. As shown in FIG. 32, velocities of the vehicle 306 and their scores are stored in an associated manner in the database 156 shown in FIG. 31. As shown in FIG. 32, a score A is “0” when the velocity is 30 to 100 km/h. Further, when the velocity is 110 km/h, it is associated with a score A “1”. Further, when the velocity is 120 km/h, it is associated with a score A “2”. Further, when the velocity is 130 km/h, it is associated with a score A “3”. Further, when the velocity is 140 km/h, it is associated with a score A “4”. Further, when the velocity is 150 km/h, it is associated with a score A “5”. Further, when the velocity is 160 km/h, it is associated with a score A “6”.

In the case where association between velocities and their scores like the one shown in FIG. 32 is stored in the database 156, when the velocity calculated by the movement amount calculation unit 116 is, for example, 120 km/h, the score acquisition unit 166 acquires “2” as the score.

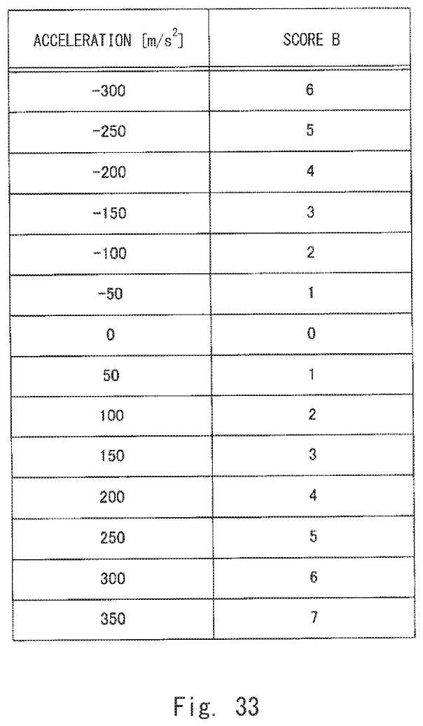

FIG. 33 shows an example of association between accelerations, which are movements of the vehicle 306, and their scores, stored in the database 156 shown in FIG. 31. As shown in FIG. 33, accelerations of the vehicle 306 and their scores are stored in an associated manner in the database 156 shown in FIG. 31. As shown in FIG. 33, accelerations −300 m/s² and 300 m/s² are associated with a score B “6”. Further, accelerations −250 m/s² and 250 m/s² are associated with a score B “5”. Further, accelerations −200 m/s² and 200 m/s² are associated with a score B “4”. Further, accelerations −150 m/s² and 150 m/s² are associated with a score B “3”. Further, accelerations −100 m/s² and 100 m/s² are associated with a score B “2”. Further, accelerations −50 m/s² and 50 m/s² are associated with a score B “1”. Further, an acceleration 0 m/s² is associated with a score B “0”. Further, an acceleration 350 m/s² is associated with a score B “7”.

In the case where association between accelerations and their scores like the one shown in FIG. 33 is stored in the database 156, when the acceleration calculated by the movement amount calculation unit 116 is, for example, 50 m/s², the score acquisition unit 166 acquires “1” as the score.

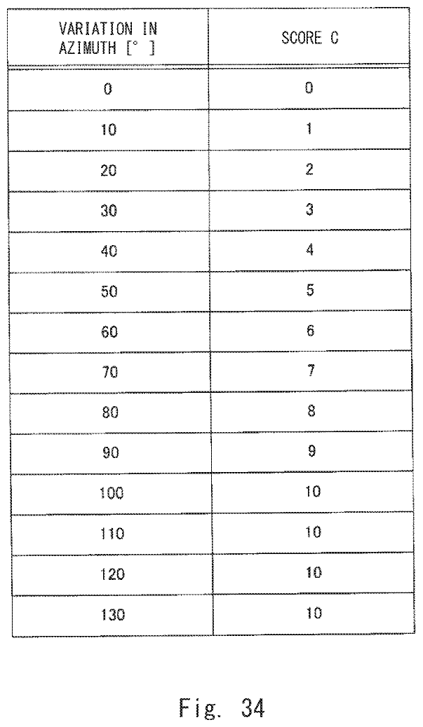

FIG. 34 shows an example of association between azimuths, which are movements of the vehicle 306, and their scores, stored in the database 156 shown in FIG. 31. As shown in FIG. 34, azimuths of the movement of the vehicle 306 and their scores are stored in an associated manner in the database 156 shown in FIG. 31. As shown in FIG. 34, an azimuth “0” is associated with a score C “0”.

Further, an azimuth “10°” is associated with a score C “1”. Further, an azimuth “20°” is associated with a score C “2”. Further, an azimuth “30°” is associated with a score C “3”. Further, an azimuth “40°” is associated with a score C “4”. Further, an azimuth “50°” is associated with a score C “5”. Further, an azimuth “60°” is associated with a score C “6”. Further, an azimuth “70°” is associated with a score C “7”. Further, an azimuth “80°” is associated with a score C “8”. Further, an azimuth “90°” is associated with a score C “9”. Further, azimuths “100° to 130°” are associated with a score C “10”.

In the case where association between azimuths and their scores like the one shown in FIG. 34 is stored in the database 156, when the azimuth calculated by the movement amount calculation unit 116 is, for example, 20°, the score acquisition unit 166 acquires “2” as the score.

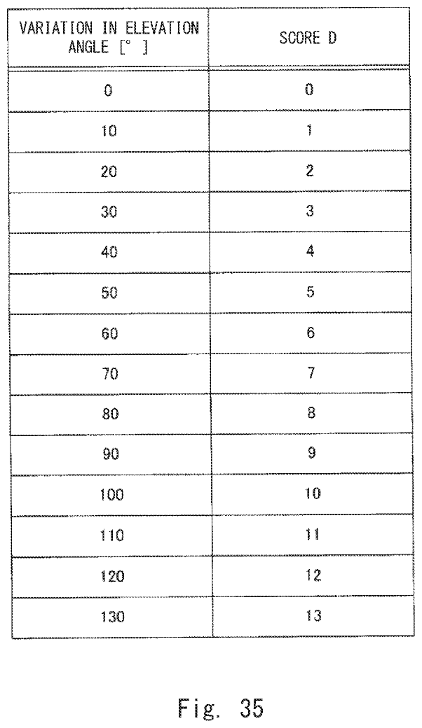

FIG. 35 shows an example of association between elevation angles, which are movements of the vehicle 306, and their scores, stored in the database 156 shown in FIG. 31. As shown in FIG. 35, elevation angles of the movement of the vehicle 306 and their scores are stored in an associated manner in the database 156 shown in FIG. 31. As shown in FIG. 35, an elevation angle “0°” is associated with a score D “0”. Further, an elevation angle “10°” is associated with a score D “1”. Further, an elevation angle “20°” is associated with a score D “2”. Further, an elevation angle “30°” is associated with a score D “3”. Further, an elevation angle “40°” is associated with a score D “4”. Further, an elevation angle “50°” is associated with a score D “5”. Further, an elevation angle “60°” is associated with a score D “6”. Further, an elevation angle “70°” is associated with a score D “7”. Further, an elevation angle “80°” is associated with a score D “8”. Further, an elevation angle “90°” is associated with a score D “9”. Further, an elevation angle “100°” is associated with a score D “10”. Further, an elevation angle “110°” is associated with a score D “11”. Further, an elevation angle “120°” is associated with a score D “12”. Further, an elevation angle “130°” is associated with a score D “13”.

In the case where association between elevation angles and their scores like the one shown in FIG. 35 is stored in the database 156, when the elevation angle calculated by the movement amount calculation unit 116 is, for example, 30°, the score acquisition unit 166 acquires “3” as the score.

The values of the scores shown in FIGS. 32 to 35 and thresholds used for comparisons described below may be statistically calculated in advance based on ordinary movements of the object. Alternatively, these values may be defined in advance as target values at the time of development so as to enhance the performance of the apparatus.

Operations of the output unit 136 that are performed when the scores shown in FIGS. 32 to 35 are used are described. For example, when the scores A, B, C and D acquired by the score acquisition unit 166 are “1”, “1”, “1” and “0”, respectively, the output unit 136 compares the sum total of these values, i.e., a value “3” with a predetermined threshold. When the threshold is “5”, the output unit 136 outputs a result of positioning using the positional information transmitted from the receiver 406. On the other hand, when the sum total of the scores A to D is “7”, it exceeds the threshold “5”. Therefore, the output unit 136 outputs a result of positioning using other positional information different from the positional information transmitted from the receiver 406.

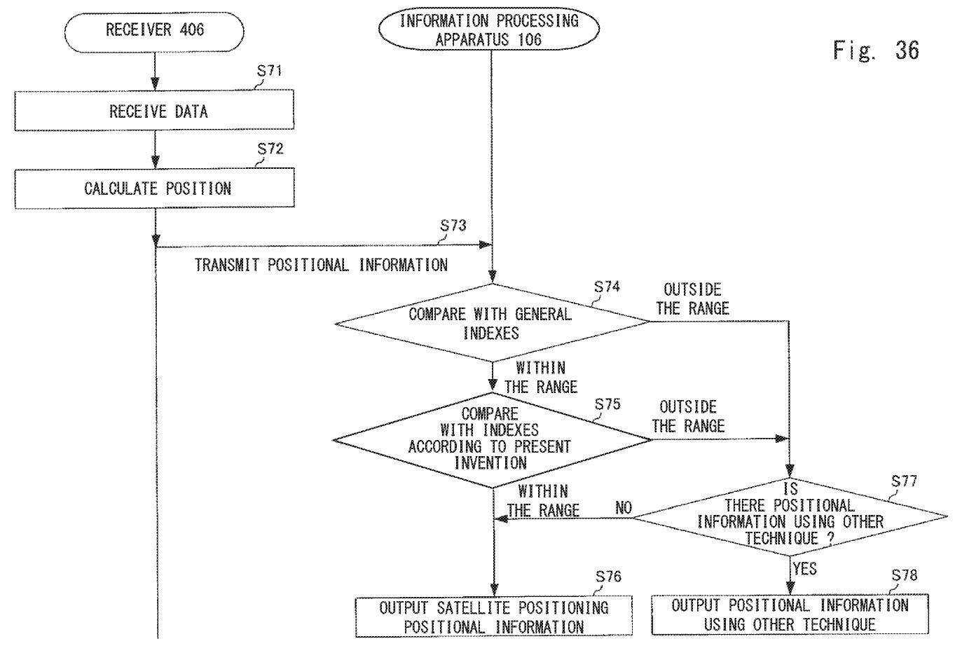

A method for outputting a result of positioning in the information processing system shown in FIG. 29 will be described hereinafter. FIG. 36 is a sequence diagram for explaining an example of a method for outputting a result of positioning in the information processing system shown in FIG. 29.

Firstly, when the receiving unit 426 of the receiver 406 receives data from the GPS satellite 206 (step S71), the transmitting unit 416 calculates the position of the vehicle 306 based on the received data (positioning calculation) (step S72). Next, the transmitting unit 106 transmits positional information indicating the calculated position to the information processing apparatus 416 (step S73).

In response, the positional information acquisition unit 146 acquires the positional information transmitted from the transmitting unit 416. Next, the score acquisition unit 166 compares the current environment with general indexes (step S74). The process in the step S74 is the same as the process in the step S24 described above with reference to the sequence diagram shown in FIG. 12. Further, the process in the step S74 may not be performed.

When the score acquisition unit 162 determines that the general indexes are within the ranges, it performs comparisons with indexes according to the present invention (step S75). The comparison process in the step S75 will be described hereinafter.

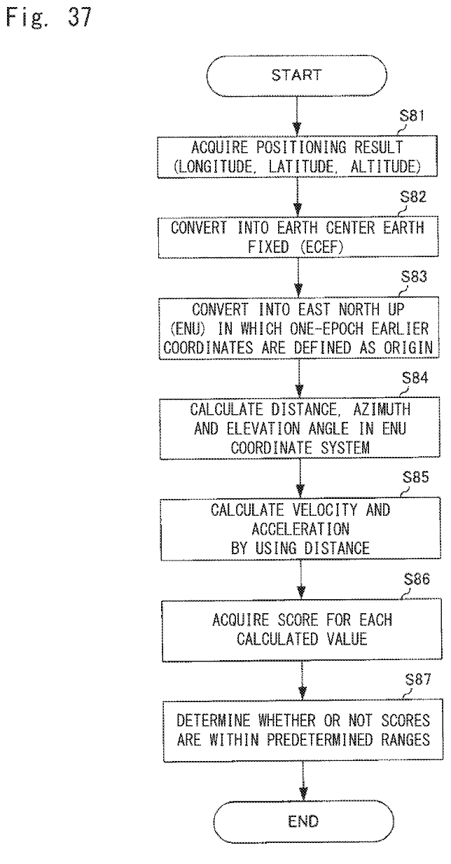

FIG. 37 is a flowchart for explaining details of the process in the step S75 described above with reference to FIG. 36. Firstly, the positional information acquisition unit 146 acquires results of positioning in regard to the latitude, the longitude, and the altitude (step S81). Next, the movement amount calculation unit 116 converts the acquired parameters in regard to the latitude, the longitude, and the altitude into the Earth Center Earth Fixed (ECEF) (step S82). Then, the movement amount calculation unit 116 converts the converted coordinates into the East North Up (ENU) in which one-epoch earlier coordinates are defined as the origin (step S83). In this example, one epoch is 50 ms.

The movement amount calculation unit 116 calculates a distance the vehicle 306 has moved, and an azimuth and an elevation angle of the movement in the ENU coordinate system (step S84). Further, the movement amount calculation unit 116 calculates the velocity and the acceleration of the vehicle 306 based on the calculated distance (step S85).

Then, the score acquisition unit 166 acquires scores corresponding to the velocity, the acceleration, the azimuth, and the elevation angle, respectively, of the vehicle 306 calculated by the movement amount calculation unit 116 from the database 156 (step S86). The score acquisition unit 166 adds up the scores acquired according to the velocity, the acceleration, the azimuth, and the elevation angle, respectively, of the vehicle 306 calculated by the movement amount calculation unit 116, and thereby calculates the sum total of the scores. The score acquisition unit 166 compares the sum total of the scores with a predetermined threshold and thereby determines whether or not the movement of the vehicle 306 is within a predetermined range (step S87).

When it is determined that the movement of the vehicle 306 is within the predetermined range by using the indexes according to the present invention in the step S75, the output unit 136 outputs satellite positioning positional information (step S76). Note that the satellite positioning positional information is the positional information transmitted from the receiver 406.

On the other hand, when it is determined that the measured values are outside the predetermined ranges in the step S74 or when it is determined that the measured values are outside the predetermined ranges in the step S75, the output unit 136 determines whether or not there is positional information using other techniques (step S77). When the output unit 136 determines that there is no positional information using other techniques, it performs a process in a step S76. On the other hand, when the output unit 136 determines that there is positional information using other techniques, it outputs the positional information using the other technique (step S78).

Note that the process in the step S72 may be performed by either the receiver 406 or the information processing apparatus 106. That is, the receiver 406 may transmit the data received in the step S71 to the information processing apparatus 106 as observation data and the information processing apparatus 106 may perform positioning calculation based on the observation data transmitted from the receiver 406.

As described above, in the information processing system according to this example embodiment, the transmitting unit 416, which is included in the receiver 406 provided in the vehicle 306, calculates the position of the vehicle 306 based on the data received from the satellite, and transmits positional information indicating the calculated position to the information processing apparatus 106. The information processing apparatus 106 calculates the velocity and the acceleration of the object, and the azimuth and the elevation angle of the movement based on the transmitted positional information. Then, when the scores corresponding to the calculated values are within predetermined ranges, the information processing apparatus 106 outputs a result of positioning using the transmitted positional information. On the other hand, when the scores corresponding to the calculated values are outside the predetermined ranges, the information processing apparatus 106 outputs a result of positioning using other techniques. Therefore, it is possible to determine the reliability of a result of the satellite positioning more accurately and thereby to output a reliable positioning result.

### Eighth Example Embodiment

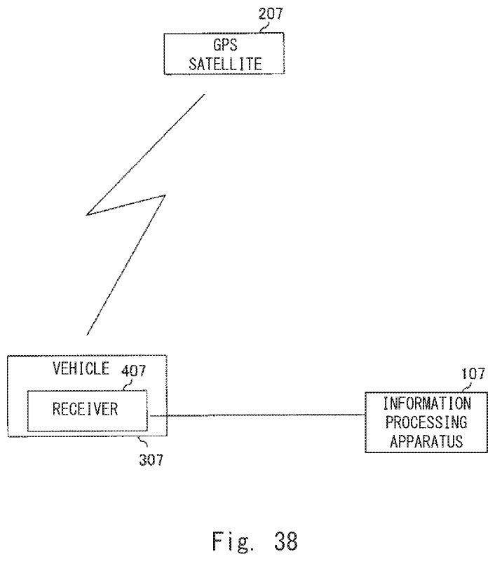

FIG. 38 shows an eighth example embodiment of an information processing apparatus according to the present invention. As shown in FIG. 38, an information processing system to which the information processing apparatus 107 according to this example embodiment is applied includes the information processing apparatus 107, a GPS satellite 207, and a vehicle 307.

The GPS satellite 207 is an artificial satellite equipped with a typical GPS function and is a satellite for measuring the position of an object by using radio waves. The GPS satellite 207 transmits data including at least transmission time information indicating a time when the GPS satellite 207 transmits the data (i.e., transmits a radio wave) and satellite positional information indicating the position of the GPS satellite 207 to the vehicle 307.

The vehicle 307 is an object whose position is to be measured. The vehicle 307 includes a receiver 407. The receiver 407 receives data from the GPS satellite 207. The data that the receiver 407 receives from the GPS satellite 207 includes at least transmission time information indicating a time when the GPS satellite 207 transmits the data (i.e., transmits a radio wave) and satellite positional information indicating the position of the GPS satellite 207. Further, the data that the receiver 407 receives from the GPS satellite 207 may include orbit information indicating the orbit of the GPS satellite 207, strength information indicating the strength of the radio wave, etc. The receiver 407 calculates the position of the receiver 407 (the vehicle 307) based on the data received from the GPS satellite 207. The receiver 407 transmits positional information indicating the calculated position to the information processing apparatus 107.

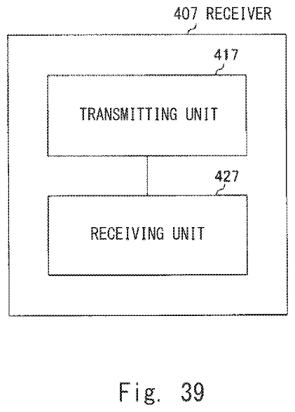

FIG. 39 shows an example of an internal configuration of the receiver 407 shown in FIG. 38. As shown in FIG. 39, the receiver 407 shown in FIG. 38 includes a transmitting unit 417 and a receiving unit 427. Note that FIG. 39 shows an example of main components related to this example embodiment among the components included in the receiver 407 shown in FIG. 38. The transmitting unit 417 performs the above-described process performed by the receiver 407. The receiving unit 427 receives data from the GPS satellite 207.

The information processing apparatus 107 performs a process based on the positional information transmitted from the receiver 407. Note that although FIG. 38 shows a configuration in which the receiver 407 provided in the vehicle 307 is connected to the information processing apparatus 107 in a one-to-one manner, the connection between these entities may be any type of connection as long as the entities can exchange information with each other through, for example, a communication network.

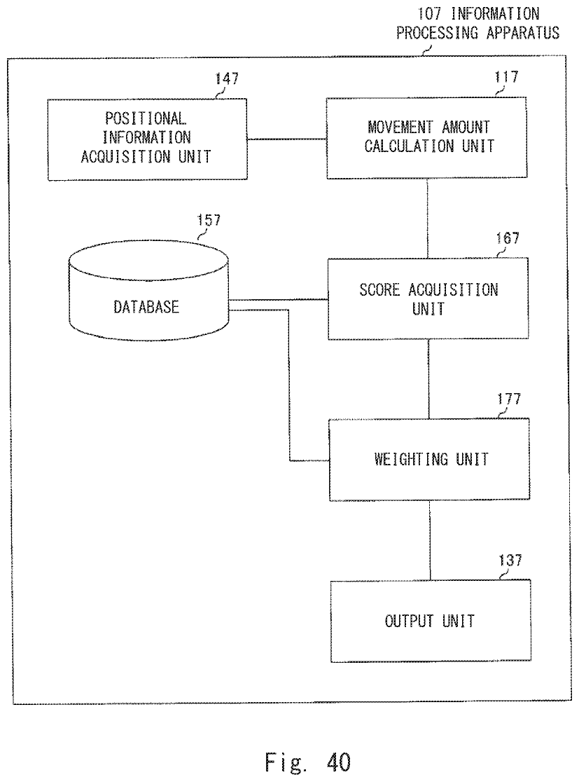

FIG. 40 shows an example of an internal configuration of the information processing apparatus 107 shown in FIG. 38. As shown in FIG. 40, the information processing apparatus 107 shown in FIG. 38 includes a movement amount calculation unit 117, a score acquisition unit 167, a weighting unit 177, an output unit 137, a positional information acquisition unit 147, and a database 157. Note that FIG. 40 shows an example of main components related to this example embodiment among the components included in the information processing apparatus 107 according to this example embodiment.

The positional information acquisition unit 147 acquires positional information transmitted from the receiver 407.

The movement amount calculation unit 117 calculates a movement of the vehicle 307 based on the positional information acquired by the positional information acquisition unit 147. Specifically, the movement amount calculation unit 117 calculates a moving speed of the vehicle 307 as a movement of the vehicle 307 based on the positional information acquired by the positional information acquisition unit 147. Further, the movement amount calculation unit 117 calculates an acceleration of the vehicle 307 as a movement of the vehicle 307 based on the positional information acquired by the positional information acquisition unit 147. Further, the movement amount calculation unit 117 calculates a moving angle of the vehicle 307 with respect to a direction parallel to the ground surface as a movement of the vehicle 307 based on the positional information acquired by the positional information acquisition unit 147. Further, the movement amount calculation unit 117 calculates a moving angle of the vehicle 307 with respect to a direction perpendicular to the ground surface as a movement of the vehicle 307 based on the positional information acquired by the positional information acquisition unit 147. Further, the movement amount calculation unit 117 calculates the movement of the vehicle 307 based on a plurality of positional information pieces respectively acquired at predetermined cycles.

The score acquisition unit 167 acquires a score corresponding to the movement calculated by the movement amount calculation unit 117. Note that the score acquisition unit 167 acquires, from the database 157, a score that is stored in the database 157 in association with the movement calculated by the movement amount calculation unit 117.

The weighting unit 177 assigns a predetermined weight to the score acquired by the score acquisition unit 167. The weighting value may be stored in the database 157 in advance.

The output unit 137 outputs a result of positioning using positional information of the vehicle 307 based on the score weighted by the weighting unit 177. Note that when the score weighted by the weighting unit 177 is equal to or lower than a predetermined threshold, the output unit 137 outputs a result of positioning using the positional information of the vehicle 307 which has been calculated by the receiver 407 based on the data received from the GPS satellite 207, i.e., the positional information transmitted from the receiver 407. On the other hand, when the score weighted by the weighting unit 177 exceeds the predetermined threshold, the output unit 137 outputs a result of positioning using other positional information, different from the result of positioning using the positional information of the vehicle 307 which has been calculated by the receiver 407 based on the data received from the GPS satellite 207, i.e., the positional information transmitted from the receiver 407. Further, the output unit 137 outputs the score weighted by the weighting unit 177.

Movements of the vehicle 307 and their scores are stored in an associated manner in the database 157 in advance. Further, weighting values are stored in the database 157 in advance.

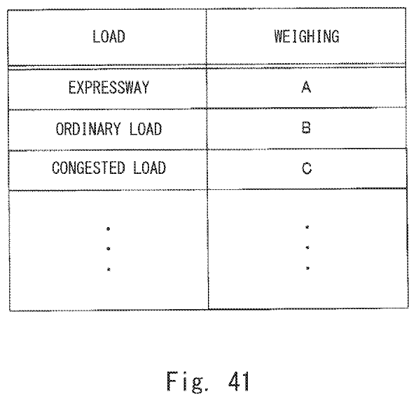

FIG. 41 shows an example of weighting values stored in the database 157 shown in FIG. 40. As shown in FIG. 41, weights corresponding to types of roads (road conditions) are stored in the database 157 shown in FIG. 40. As shown in FIG. 41, a road “expressway” is associated with a weight “A”. Further, a road “ordinary road” is associated with a weight “B”. Further, a road “congested road” is associated with a weight “C”. Note that as shown in FIGS. 32 to 35 in the seventh example embodiment, when there are a plurality of scores corresponding to movements of the vehicle 307, such as the velocity, the acceleration, the azimuth, and the elevation angle, a plurality of weights corresponding to the respective scores may be defined in advance.

In the case where association between roads and their weights like the one shown in FIG. 41 is stored in the database 157, when the road on which the vehicle 307 is currently traveling is, for example, an expressway, the weighting unit 177 outputs a value that is obtained by multiplying a score acquired by the score acquisition unit 167 by a value “A” to the output unit 137. Further, when the road on which the vehicle 307 is currently traveling is an ordinary road, the weighting unit 177 outputs a value that is obtained by multiplying the score acquired by the score acquisition unit 167 by a value “B” to the output unit 137. Further, when the road on which the vehicle 307 is currently traveling is a congested road, the weighting unit 177 outputs a value that is obtained by multiplying the score acquired by the score acquisition unit 167 by a value “C” to the output unit 137. Note that the road on which the vehicle 307 is currently traveling may be identified by using route information, sensor information, traffic-jam information, etc. which are typically provided in the GPS function or the like.

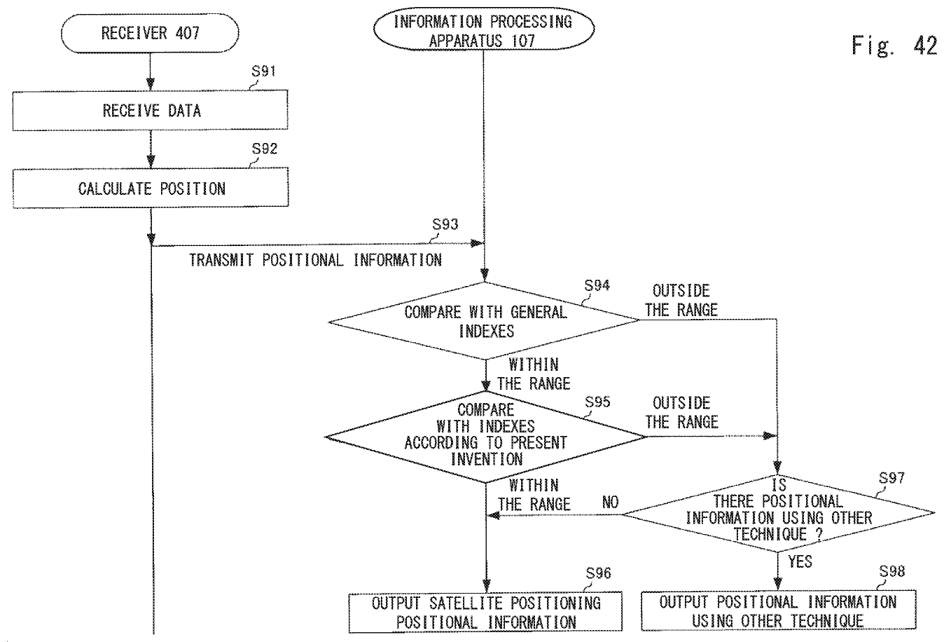

A method for outputting a result of positioning in the information processing system shown in FIG. 38 will be described hereinafter. FIG. 42 is a sequence diagram for explaining an example of a method for outputting a result of positioning in the information processing system shown in FIG. 38.

Firstly, when the receiving unit 427 of the receiver 407 receives data from the GPS satellite 207 (step S91), the transmitting unit 417 calculates the position of the vehicle 307 based on the received data (positioning calculation) (step S92). Next, the transmitting unit 107 transmits positional information indicating the calculated position to the information processing apparatus 417 (step S93).

In response, the positional information acquisition unit 147 acquires the positional information transmitted from the transmitting unit 417. Next, the score acquisition unit 167 compares the current environment with general indexes (step S94). The process in the step S94 is the same as the process in the step S24 described above with reference to the sequence diagram shown in FIG. 12.

Further, the process in the step S94 may not be performed.

When the score acquisition unit 166 determines that the general indexes are within the ranges, it performs comparisons with indexes according to the present invention (step S95). The comparison process in the step S95 will be described hereinafter.

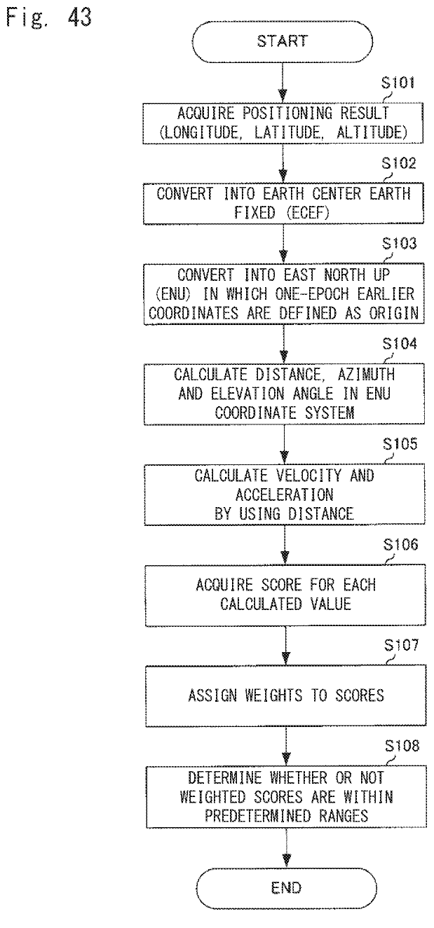

FIG. 43 is a flowchart for explaining details of the process in the step S95 described above with reference to FIG. 42. Firstly, the positional information acquisition unit 147 acquires results of positioning in regard to the latitude, the longitude, and the altitude (step S101). Next, the movement amount calculation unit 117 converts the acquired parameters in regard to the latitude, the longitude, and the altitude into the Earth Center Earth Fixed (ECEF) (step S102). Then, the movement amount calculation unit 117 converts the converted coordinates into the East North Up (ENU) in which one-epoch earlier coordinates are defined as the origin (step S103). In this example, one epoch is 50 ms.

The movement amount calculation unit 117 calculates a distance the vehicle 307 has moved, and an azimuth and an elevation angle of the movement in the ENU coordinate system (step S104). Further, the movement amount calculation unit 117 calculates the velocity and the acceleration of the vehicle 307 based on the calculated distance (step S105).

Then, the score acquisition unit 167 acquires scores corresponding to the velocity, the acceleration, the azimuth, and the elevation angle, respectively, of the vehicle 307 calculated by the movement amount calculation unit 117 from the database 157 (step S106). Next, the weighting unit 177 assigns weights that are defined according to the road conditions to the scores acquired by the score acquisition unit 167 (step S107). The weighting unit 177 adds up the scores, to which the respective weights have been assigned, and thereby calculates the sum total thereof. The weighting unit 177 compares the sum total of the weighted scores with a predetermined threshold and thereby determines whether or not the movement of the vehicle 307 is within a predetermined range (step S108).

When it is determined that the movement of the vehicle 307 is within the predetermined range by using the indexes according to the present invention in the step S95, the output unit 137 outputs satellite positioning positional information (step S96). Note that the satellite positioning positional information is the positional information transmitted from the receiver 407.

On the other hand, when it is determined that the measured values are outside the predetermined ranges in the step S94 or when it is determined that the measured values are outside the predetermined ranges in the step S95, the output unit 137 determines whether or not there is positional information using other techniques (step S97). When the output unit 137 determines that there is no positional information using other techniques, it performs a process in a step S96. On the other hand, when the output unit 137 determines that there is positional information using other techniques, it outputs the positional information using the other technique (step S98).

Note that the process in the step S92 may be performed by either the receiver 407 or the information processing apparatus 107. That is, the receiver 407 may transmit the data received in the step S91 to the information processing apparatus 107 as observation data and the information processing apparatus 107 may perform positioning calculation based on the observation data transmitted from the receiver 407.

As described above, in the information processing system according to this example embodiment, the transmitting unit 417, which is included in the receiver 407 provided in the vehicle 307, calculates the position of the vehicle 307 based on the data received from the satellite, and transmits positional information indicating the calculated position to the information processing apparatus 107. The information processing apparatus 107 calculates the velocity and the acceleration of the object, and the azimuth and the elevation angle of the movement based on the transmitted positional information, and assigns weights to the scores corresponding to the calculated values. Then, when the weighted scores are within predetermined ranges, the information processing apparatus 107 outputs a result of positioning using the transmitted positional information. On the other hand, when the weighted scores are outside the predetermined ranges, the information processing apparatus 107 outputs a result of positioning using other techniques. Therefore, it is possible to determine the reliability of a result of the satellite positioning more accurately and thereby to output a reliable positioning result.

### MODIFIED EXAMPLE

In the above-described example embodiments, the information processing apparatus outputs results. However, the information processing apparatus may transmit results to the receiver and the receiver may output the results transmitted from the information processing apparatus.

In the above descriptions, each component is assigned its respective function. However, the assignments are not limited to the above-described assignments. Further, the configurations of components in the above-described embodiments are also merely examples and are not limited to the above-shown examples. Further, the example embodiments may be combined with one another.

The process performed by each of the components provided in each of the above-described information processing apparatuses 100, 102-104, 106 and 107 may be performed by a logic circuit that is created according to its purpose. Alternatively, a computer program (hereinafter referred to as a program) in which processes are described as procedures may be recorded on a recording medium that can be read by each of the information processing apparatuses 100, 102-104, 106 and 107, and the program recorded on the recording medium may be loaded and executed by each of the information processing apparatuses 100, 102-104, 106 and 107. The recording medium readable by each of the information processing apparatuses 100, 102-104, 106 and 107 may be a memory such as a ROM (Read Only Memory), a RAM (Random Access Memory), and an HDD (Hard Disc Drive) disposed inside each of the information processing apparatuses 100, 102-104, 106 and 107 as well as a portable recording medium such as a floppy (Registered Trademark) disc, a magneto-optical disc, a DVD (Digital Versatile Disc), a CD (Compact Disc), a Blu-ray (Registered Trademark) disc, a USB (Universal Serial Bus) memory. The program recorded on the recording medium is loaded by a CPU disposed in each of the information processing apparatuses 100, 102-104, 106 and 107, and processes similar to those described above are performed under the control of the CPU. Note that the CPU operates as a computer that executes a program loaded from a recording medium on which the program is recorded.

For example, the whole or part of the example embodiments disclosed above can be described as, but not limited to, the following supplementary notes.

### (Supplementary Note 1)

An information processing apparatus comprising:

a movement amount calculation unit configured to calculate a movement of an object based on positional information indicating a position of the object calculated by satellite positioning;

a comparison unit configured to compare the movement calculated by the movement amount calculation unit with a predetermined threshold; and

an output unit configured to output a result of the comparison made in the comparison unit.

### (Supplementary Note 2)

The information processing apparatus described in Supplementary note 1, wherein the output unit outputs a result of positioning using the positional information of the object based on a result of the comparison made in the comparison unit.

### (Supplementary Note 3)

The information processing apparatus described in Supplementary note 2, wherein when the movement calculated by the movement amount calculation unit is within a predetermined range indicated by the threshold based on the result of the comparison made in the comparison unit, the output unit outputs the result of positioning using the positional information of the object.

### (Supplementary Note 4)

The information processing apparatus described in Supplementary note 2 or 3, wherein when the movement calculated by the movement amount calculation unit is not within a predetermined range indicated by the threshold based on the result of the comparison made in the comparison unit, the output unit outputs a result of positioning using other positional information, different from the result of positioning using the positional information of the object.

### (Supplementary Note 5)

An information processing apparatus comprising:

a movement amount calculation unit configured to calculate a movement of an object based on positional information indicating a position of the object calculated by satellite positioning;

a score acquisition unit configured to acquire a score corresponding to the movement calculated by the movement amount calculation unit; and

an output unit configured to output the score acquired by the score acquisition unit.

### (Supplementary Note 6)

The information processing apparatus described in Supplementary note 5, wherein the output unit outputs a result of positioning using the positional information of the object based on the score acquired by the score acquisition unit.

### (Supplementary Note 7)

The information processing apparatus described in Supplementary note 5 or 6, further comprising a weighting unit configured to assign a predetermined weight to the score acquired by the score acquisition unit, wherein the output unit outputs the score to which the weighting unit has assigned the weight.

### (Supplementary Note 8)

The information processing apparatus described in Supplementary note 7, wherein the output unit outputs a result of positioning using the positional information of the object based on the score to which the weighting unit has assigned the weight.

### (Supplementary Note 9)

The information processing apparatus described in any one of Supplementary notes 1 to 8, wherein the movement amount calculation unit calculates at least one of a moving speed of the object, an acceleration of the object, a moving angle of the object with respect to a direction parallel to a ground surface, and a moving angle of the object with respect to a direction perpendicular to the ground surface as the movement of the object based on the positional information.

### (Supplementary Note 10)

The information processing apparatus described in any one of Supplementary notes 1 to 9, wherein the movement amount calculation unit calculates the movement of the object based on a plurality of positional information pieces respectively acquired at predetermined cycles.

### (Supplementary Note 11)

The information processing apparatus described in any one of Supplementary notes 1 to 10, further comprising a positional information acquisition unit configured to acquire the positional information of the object, wherein

the movement amount calculation unit calculates the movement of the object based on the positional information acquired by the positional information acquisition unit.

### (Supplementary Note 12)

An information processing system comprising a receiver disposed in an object, and an information processing apparatus, wherein

the receiver comprises a transmitting unit configured to calculate a position of the object based on data received from a satellite configured to perform satellite positioning, and transmit positional information indicating the calculated position to the information processing apparatus, and

the information processing apparatus comprises:

a movement amount calculation unit configured to calculate a movement of an object based on the positional information transmitted from the transmitting unit;

a comparison unit configured to compare the movement calculated by the movement amount calculation unit with a predetermined threshold; and

an output unit configured to output a result of the comparison made in the comparison unit.

### (Supplementary Note 13)

The information processing system described in Supplementary note 12, wherein the output unit outputs a result of positioning using the positional information of the object based on a result of the comparison made in the comparison unit.

### (Supplementary Note 14)

The information processing system described in Supplementary note 13, wherein when the movement calculated by the movement amount calculation unit is within a predetermined range indicated by the threshold based on the result of the comparison made in the comparison unit, the output unit outputs the result of positioning using the positional information of the object.

### (Supplementary Note 15)

The information processing system described in Supplementary note 13 or 14, wherein when the movement calculated by the movement amount calculation unit is not within a predetermined range indicated by the threshold based on the result of the comparison made in the comparison unit, the output unit outputs a result of positioning using other positional information, different from the result of positioning using the positional information of the object.

### (Supplementary Note 16)

An information processing system comprising a receiver disposed in an object, and an information processing apparatus, wherein

the receiver comprises a transmitting unit configured to calculate a position of the object based on data received from a satellite configured to perform satellite positioning, and transmit positional information indicating the calculated position to the information processing apparatus, and

the information processing apparatus comprises:

a movement amount calculation unit configured to calculate a movement of an object based on the positional information transmitted from the receiver;

a score acquisition unit configured to acquire a score corresponding to the movement calculated by the movement amount calculation unit; and

an output unit configured to output the score acquired by the score acquisition unit.

### (Supplementary Note 17)

The information processing system described in Supplementary note 16, wherein the output unit outputs a result of positioning using the positional information of the object based on the score acquired by the score acquisition unit.

### (Supplementary Note 18)

The information processing system described in Supplementary note 16 or 17, wherein

the information processing apparatus comprises a weighting unit configured to assign a predetermined weight to the score acquired by the score acquisition unit, and

the output unit outputs the score to which the weighting unit has assigned the weight.

### (Supplementary Note 19)

The information processing system described in Supplementary note 18, wherein the output unit outputs a result of positioning using the positional information of the object based on the score to which the weighting unit has assigned the weight.

### (Supplementary Note 20)

The information processing system described in any one of Supplementary notes 12 to 19, wherein the movement amount calculation unit calculates at least one of a moving speed of the object, an acceleration of the object, a moving angle of the object with respect to a direction parallel to a ground surface, and a moving angle of the object with respect to a direction perpendicular to the ground surface as the movement of the object based on the positional information.

### (Supplementary Note 21)

The information processing system described in any one of Supplementary notes 12 to 20, wherein the movement amount calculation unit calculates the movement of the object based on a plurality of positional information pieces respectively acquired at predetermined cycles.

### (Supplementary Note 22)

The information processing system described in any one of Supplementary notes 12 to 21, further comprising a positional information acquisition unit configured to acquire the positional information transmitted from the receiver, wherein

the movement amount calculation unit calculates the movement of the object based on the positional information acquired by the positional information acquisition unit.

### (Supplementary Note 23)

A method for outputting a result of positioning, comprising:

a process of calculating a movement of an object based on positional information indicating a position of the object calculated by satellite positioning;

a process of comparing the calculated movement with a predetermined threshold; and

a process of outputting a result of the comparison.

### (Supplementary Note 24)

The method for outputting a result of positioning described in Supplementary note 23, further comprising a process of outputting a result of positioning using the positional information of the object based on a result of the comparison.

### (Supplementary Note 25)

The method for outputting a result of positioning described in Supplementary note 24, further comprising a process of outputting, when the calculated movement is within a predetermined range indicated by the threshold based on the result of the comparison, the result of positioning using the positional information of the object.

### (Supplementary Note 26)

The method for outputting a result of positioning described in Supplementary note 24 or 25, further comprising a process of outputting, when the calculated movement is not within a predetermined range indicated by the threshold based on the result of the comparison, a result of positioning using other positional information, different from the result of positioning using the positional information of the object.

### (Supplementary Note 27)

A method for outputting a result of positioning, comprising;

a process of calculating a movement of an object based on positional information indicating a position of the object calculated by satellite positioning;

a process of acquiring a score corresponding to the calculated movement; and

a process of outputting the acquired score.

### (Supplementary Note 28)

The method for outputting a result of positioning described in Supplementary note 27, further comprising a process of outputting a result of positioning using the positional information of the object based on the acquired score.

### (Supplementary Note 29)

The method for outputting a result of positioning described in Supplementary note 28, further comprising:

a process of assigning a predetermined weight to the acquired score; and

a process of outputting the score to which the weight has been assigned.

### (Supplementary Note 30)

The method for outputting a result of positioning described in Supplementary note 29, further comprising:

a process of outputting a result of positioning using the positional information of the object based on the score to which the weight has been assigned.

### (Supplementary Note 31)

The method for outputting a result of positioning described in any one of Supplementary notes 23 to 30, further comprising a process of calculating at least one of a moving speed of the object, an acceleration of the object, a moving angle of the object with respect to a direction parallel to a ground surface, and a moving angle of the object with respect to a direction perpendicular to the ground surface as the movement of the object based on the positional information.

### (Supplementary Note 32)

The method for outputting a result of positioning described in any one of Supplementary notes 23 to 31, further comprising a process of calculating the movement of the object based on a plurality of positional information pieces respectively acquired at predetermined cycles.

### (Supplementary Note 33)

The method for outputting a result of positioning described in any one of Supplementary notes 23 to 32, further comprising a process of acquiring the positional information of the object.

### (Supplementary Note 34)

A program for causing a computer to execute:

a procedure of calculating a movement of an object based on positional information indicating a position of the object calculated by satellite positioning;

a procedure of comparing the calculated movement with a predetermined threshold; and

a procedure of outputting a result of the comparison.

### (Supplementary Note 35)

The program described in Supplementary note 34, further causing the computer to execute a procedure of outputting a result of positioning using the positional information of the object based on a result of the comparison.

### (Supplementary Note 36)

The program described in Supplementary note 35, further causing the computer to execute a procedure of outputting, when the calculated movement is within a predetermined range indicated by the threshold based on the result of the comparison, the result of positioning using the positional information of the object.

### (Supplementary Note 37)

The program described in Supplementary note 35 or 36, further causing the computer to execute a procedure of outputting, when the calculated movement is not within a predetermined range indicated by the threshold based on the result of the comparison, a result of positioning using other positional information, different from the result of positioning using the positional information of the object.

### (Supplementary Note 38)

A program for causing a computer to execute:

a procedure of calculating a movement of an object based on positional information indicating a position of the object calculated by satellite positioning;

a procedure of acquiring a score corresponding to the calculated movement; and

a procedure of outputting the acquired score.

### (Supplementary Note 39)

The program described in Supplementary note 38, further causing the computer to execute a procedure of outputting a result of positioning using the positional information of the object based on the acquired score.

### (Supplementary Note 40)

The program described in Supplementary note 38 or 39, further causing the computer to execute:

a procedure of assigning a predetermined weight to the acquired score; and

a procedure of outputting the score to which the weight has been assigned.

### (Supplementary Note 41)

The program described in Supplementary note 40, further causing the computer to execute:

a procedure of outputting a result of positioning using the positional information of the object based on the score to which the weight has been assigned.

### (Supplementary Note 42)

The program described in any one of Supplementary notes 34 to 41, further causing the computer to execute a procedure of calculating at least one of a moving speed of the object, an acceleration of the object, a moving angle of the object with respect to a direction parallel to a ground surface, and a moving angle of the object with respect to a direction perpendicular to the ground surface as the movement of the object based on the positional information.

### (Supplementary Note 43)

The program described in any one of Supplementary notes 34 to 42, further causing the computer to execute a procedure of calculating the movement of the object based on a plurality of positional information pieces respectively acquired at predetermined cycles.

### (Supplementary Note 44)

The program described in any one of Supplementary notes 34 to 43, further causing the computer to execute a procedure of acquiring the positional information of the object.

This application is based upon and claims the benefit of priority from Japanese patent application No. 2017-170169, filed on Sep. 5, 2017, the disclosure of which is incorporated herein in its entirety by reference.

### REFERENCE SIGNS LIST

100, 102-104, 106, 107 INFORMATION PROCESSING APPARATUS
110, 112-114, 116, 117 MOVEMENT AMOUNT CALCULATION UNIT
120, 122, 123 COMPARISON UNIT
130, 132-134, 136, 137 OUTPUT UNIT
142, 143, 146, 147 POSITIONAL INFORMATION ACQUISITION UNIT
152, 153, 156, 157 DATABASE
164, 166, 167 SCORE ACQUISITION UNIT
177 WEIGHTING UNIT
201, 205 SATELLITE
202, 203, 206, 207 GPS SATELLITE
301, 305 OBJECT
302, 303, 306, 307 VEHICLE
401-403, 405-407 RECEIVER
411-413, 415-417 TRANSMITTING UNIT
421-423, 425-427 RECEIVING UNIT

What is claimed is:

1. An information processing apparatus comprising:
movement amount calculation unit for calculating a movement of an object based on positional information indicating a position of the object calculated by satellite positioning;
comparison unit for comparing the movement calculated by the movement amount calculation unit with a predetermined threshold; and
output unit for outputting a result of the comparison made in the comparison unit.

2. The information processing apparatus according to claim 1, wherein the output unit outputs a result of positioning using the positional information of the object based on a result of the comparison made in the comparison unit.

3. The information processing apparatus according to claim 2, wherein when the movement calculated by the movement amount calculation unit is within a predetermined range indicated by the threshold based on the result of the comparison made in the comparison unit, the output unit outputs the result of positioning using the positional information of the object.

4. The information processing apparatus according to claim 2, wherein when the movement calculated by the movement amount calculation unit is not within a predetermined range indicated by the threshold based on the result of the comparison made in the comparison unit, the output unit outputs a result of positioning using other positional information, different from the result of positioning using the positional information of the object.

5. An information processing apparatus comprising:
movement amount calculation unit for calculating a movement of an object based on positional information indicating a position of the object calculated by satellite positioning;
score acquisition unit for acquiring a score corresponding to the movement calculated by the movement amount calculation unit; and
output unit for outputting the score acquired by the score acquisition unit.

6. The information processing apparatus according to claim 5, wherein the output unit outputs a result of positioning using the positional information of the object based on the score acquired by the score acquisition unit.

7. The information processing apparatus according to claim 5, further comprising weighting unit for assigning a predetermined weight to the score acquired by the score acquisition unit, wherein
the output unit outputs the score to which the weighting unit has assigned the weight.

8. The information processing apparatus according to claim 7, wherein the output unit outputs a result of positioning using the positional information of the object based on the score to which the weighting unit has assigned the weight.

9. The information processing apparatus according to claim 1, wherein the movement amount calculation moans unit calculates at least one of a moving speed of the object, an acceleration of the object, a moving angle of the object with respect to a direction parallel to a ground surface, and a moving angle of the object with respect to a direction perpendicular to the ground surface as the movement of the object based on the positional information.

10. The information processing apparatus according to claim 1, wherein the movement amount calculation unit calculates the movement of the object based on a plurality of positional information pieces respectively acquired at predetermined cycles.

11. The information processing apparatus according to claim 1, further comprising positional information acquisition unit for acquiring the positional information of the object, wherein
the movement amount calculation unit calculates the movement of the object based on the positional information acquired by the positional information acquisition unit.

12.-13. (canceled)

14. A method for outputting a result of positioning, comprising:
a process of calculating a movement of an object based on positional information indicating a position of the object calculated by satellite positioning;
a process of comparing the calculated movement with a predetermined threshold; and
a process of outputting a result of the comparison.

15.-17. (canceled)

18. The method for outputting a result of positioning according to claim 14, further comprising a process of outputting a result of positioning using the positional information of the object based on a result of the comparison.

19. The method for outputting a result of positioning according to claim 18, further comprising a process of outputting, when the calculated movement is within a predetermined range indicated by the threshold based on the result of the comparison, the result of positioning using the positional information of the object.

20. The method for outputting a result of positioning according to claim 18, further comprising a process of outputting, when the calculated movement is not within a predetermined range indicated by the threshold based on the result of the comparison, a result of positioning using other positional information, different from the result of positioning using the positional information of the object.

21. The method for outputting a result of positioning according to claim 14, further comprising a process of calculating at least one of a moving speed of the object, an acceleration of the object, a moving angle of the object with respect to a direction parallel to a ground surface, and a moving angle of the object with respect to a direction perpendicular to the ground surface as the movement of the object based on the positional information.

22. The method for outputting a result of positioning according to claim 14, further comprising a process of calculating the movement of the object based on a plurality of positional information pieces respectively acquired at predetermined cycles.

23. The method for outputting a result of positioning according to claim 14, further comprising a process of acquiring the positional information of the object.
